(19) United States
(12) Patent Application Publication
(10) Pub. No.: US 2026/0131655 A1
(43) Pub. Date: May 14, 2026

(54) VEHICLE CONTROL METHOD AND DISPLAY DEVICE

(71) Applicant: PANASONIC AUTOMOTIVE SYSTEMS CO., LTD., Kanagawa (JP)

(72) Inventors: Tsuyoshi NISHIO, Chiba (JP); Toshihiro MIYAMICHI, Kanagawa (JP)

(73) Assignee: Panasonic Automotive Systems Co., Ltd., Kanagawa (JP)

(21) Appl. No.: 19/413,867

(22) Filed: Dec. 9, 2025

Related U.S. Application Data
(63) Continuation of application No. PCT/JP2024/018530, filed on May 20, 2024.

(30) Foreign Application Priority Data
Aug. 9, 2023 (JP) 2023-130287
Aug. 9, 2023 (JP) 2023-130288

(51) Int. Cl. B60K 35/29; B60K 35/81

(52) U.S. Cl. CPC B60K 35/29; B60K 35/81; B60K 2360/741

(57) ABSTRACT

An occupant can view a video on a display installed inside a vehicle, and car sickness of the occupant is prevented. The vehicle includes a display disposed between a rear seat and a front seat, if a first condition is satisfied, the display displays a video in a first size with a video center at a first position, and if a second condition different from the first condition is satisfied, the display displays the video in a second size smaller than the first size with the video center at a second position.

### TECHNICAL FIELD

The present disclosure relates to a vehicle control method and a display device.

### BACKGROUND ART

It is known that car sickness is likely to occur when a video or the like is viewed inside a vehicle. Patent Literature 1 discloses a vehicle control system including an autonomous driving control unit that executes autonomous driving in which at least one of speed control and steering control of a vehicle is automatically controlled, a display unit that displays content, and a display control unit that, when the autonomous driving is being executed by autonomous driving control unit, changes content that can be displayed during the autonomous driving according to a behavior of the vehicle, and displays the content on the display unit.

### CITATION LIST

### Patent Literature

Patent Literature 1: JP2018-76027A.

Patent Literature 2: JP2015-141099A.

Patent Literature 3: JP2013-16692A.

Patent Literature 4: JP 2021-93083A.

### SUMMARY OF INVENTION

When a video displayed on a large display installed inside the vehicle is viewed, car sickness is more likely to occur. On the other hand, there is a need to view a video on the display installed inside the vehicle.

An object of the present disclosure is to provide a technique for allowing an occupant to view a video on a display installed inside a vehicle and preventing car sickness of the occupant.

An aspect of the present disclosure provides a vehicle control method for a vehicle, the vehicle includes at least
a first wheel coupled to a vehicle body,
a second wheel coupled to the vehicle body,
a third wheel coupled to the vehicle body, and
a fourth wheel coupled to the vehicle body,

the vehicle is capable of traveling in a predetermined direction using the first wheel, the second wheel, the third wheel, and the fourth wheel,

the vehicle body includes
a floor surface portion and a ceiling surface portion disposed along the predetermined direction,
a left side surface portion connecting the floor surface portion and the ceiling surface portion and disposed on a left side surface along the predetermined direction,
a right side surface portion connecting the floor surface portion and the ceiling surface portion and disposed on a right side surface along the predetermined direction,
a front surface portion connecting the floor surface portion and the ceiling surface portion and disposed in a front portion along the predetermined direction,
a rear surface portion connecting the floor surface portion and the ceiling surface portion and disposed in a rear portion along the predetermined direction,
at least one front seat disposed closer to a front surface portion side than the rear surface portion on the floor surface portion,
at least one rear seat disposed closer to a rear surface portion side than the front surface portion on the floor surface portion, and
a display disposed between the rear seat and the front seat,

when a first condition is satisfied, the display displays a video in a first size with a video center at a first position, and

when a second condition different from the first condition is satisfied, the display displays the video in a second size smaller than the first size with the video center at a second position.

An aspect of the present disclosure provides a display device mounted on a vehicle, the vehicle includes at least
a first wheel coupled to a vehicle body,
a second wheel coupled to the vehicle body,
a third wheel coupled to the vehicle body, and
a fourth wheel coupled to the vehicle body,

the vehicle is capable of traveling in a predetermined direction using the first wheel, the second wheel, the third wheel, and the fourth wheel,

the vehicle body includes
a floor surface portion and a ceiling surface portion disposed along the predetermined direction,
a left side surface portion connecting the floor surface portion and the ceiling surface portion and disposed on a left side surface along the predetermined direction,
a right side surface portion connecting the floor surface portion and the ceiling surface portion and disposed on a right side surface along the predetermined direction,
a front surface portion connecting the floor surface portion and the ceiling surface portion and disposed in a front portion along the predetermined direction,
a rear surface portion connecting the floor surface portion and the ceiling surface portion and disposed in a rear portion along the predetermined direction,
at least one front seat disposed closer to a front surface portion side than the rear surface portion on the floor surface portion,
at least one rear seat disposed closer to a rear surface portion side than the front surface portion on the floor surface portion, and
a display disposed between the rear seat and the front seat,

when a first condition is satisfied, the display displays a video in a first size with a video center at a first position, and

when a second condition different from the first condition is satisfied, the display displays the video in a second size smaller than the first size with the video center at a second position.

These comprehensive or specific aspects may be implemented by a system, a device, a method, an integrated circuit, a computer program, or a recording medium, or any combination of the system, the device, the method, the integrated circuit, the computer program, and the recording medium.

According to the present disclosure, an occupant can view a video on a display installed inside a vehicle, and car sickness of the occupant can be prevented.

### BRIEF DESCRIPTION OF DRAWINGS

FIG. 1 is a plan view illustrating a configuration example of a vehicle according to Embodiment 1, as seen through inside of the vehicle from above;

FIG. 2 is a side view illustrating the configuration example of the vehicle according to Embodiment 1, as seen through inside of the vehicle from a side;

FIG. 3 is a diagram illustrating the configuration example of the vehicle according to Embodiment 1, as seen forward from a rear seat inside the vehicle;

FIG. 4 is a block diagram illustrating an example of a device provided in the vehicle according to Embodiment 1;

FIG. 5 is a diagram illustrating an example of displaying a video in a first display mode on a display according to Embodiment 1;

FIG. 6 is a diagram illustrating an example of displaying a video in a second display mode on the display according to Embodiment 1;

FIG. 7 is a diagram illustrating an example of displaying a video in a third display mode on the display according to Embodiment 1;

FIG. 8 is a diagram illustrating a case where an occupant instructs to change a display mode of a video according to Embodiment 1;

FIG. 9 is a flowchart illustrating an example of a display process according to Embodiment 1;

FIG. 10 is a flowchart illustrating processes following the display process illustrated in FIG. 9;

FIG. 11 is a diagram illustrating an example of a change in acceleration of the vehicle and a change in display mode of the display according to Embodiment 1;

FIG. 12 is a plan view illustrating a configuration example of a vehicle according to Embodiment 2, as seen through inside of the vehicle from above;

FIG. 13 is a side view illustrating the configuration example of the vehicle according to Embodiment 2, as seen through inside of the vehicle from a side;

FIG. 14 is a diagram illustrating the configuration example of the vehicle according to Embodiment 2, as seen forward from a rear seat inside the vehicle;

FIG. 15 is a block diagram illustrating an example of a device provided in the vehicle according to Embodiment 2;

FIG. 16 is a schematic diagram illustrating an example of first content according to Embodiment 2;

FIG. 17 is a schematic diagram illustrating a video of a predetermined pattern as an example of second content according to Embodiment 2;

FIG. 18 is a schematic diagram illustrating a video of a swinging curtain as an example of the second content according to Embodiment 2;

FIG. 19 is a schematic diagram illustrating a video of a water surface with waves as an example of the second content according to Embodiment 2;

FIG. 20 is a schematic diagram illustrating an example of a video of a grass swaying in wind as an example of the second content according to Embodiment 2;

FIG. 21 is a schematic diagram illustrating a video of a cactus as an example of the second content according to Embodiment 2;

FIG. 22 is a schematic diagram illustrating a video of fish swimming in water as an example of the second content according to Embodiment 2;

FIG. 23 is a schematic diagram illustrating an example of a video of clouds flowing as an example of the second content according to Embodiment 2;

FIG. 24 is a flowchart illustrating an example of a situation determination process according to Embodiment 2;

FIG. 25 is a flowchart illustrating an example of a process B following the process illustrated in FIG. 24;

FIG. 26 is a flowchart illustrating an example of a getting-on process according to Embodiment 2; and

FIG. 27 is a flowchart illustrating an example of a getting-off process according to Embodiment 2.

### DESCRIPTION OF EMBODIMENTS

Hereinafter, embodiments of the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to sufficiently understand the present disclosure, and are not intended to limit the subject matter described in the claims.

### Embodiment 1

### <Configuration of Vehicle>

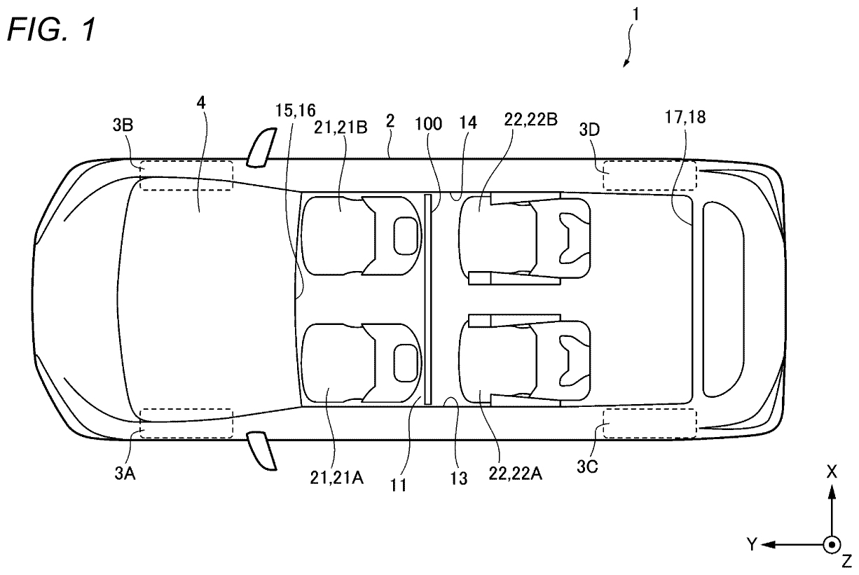

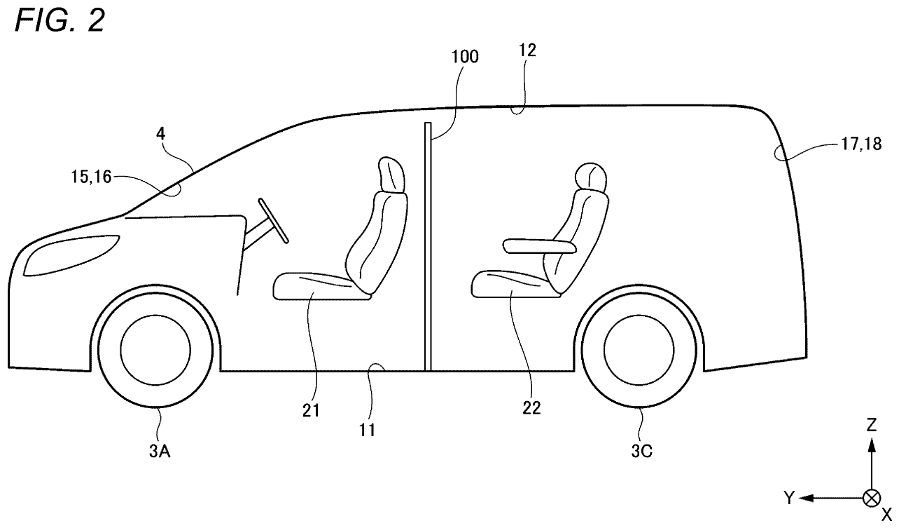

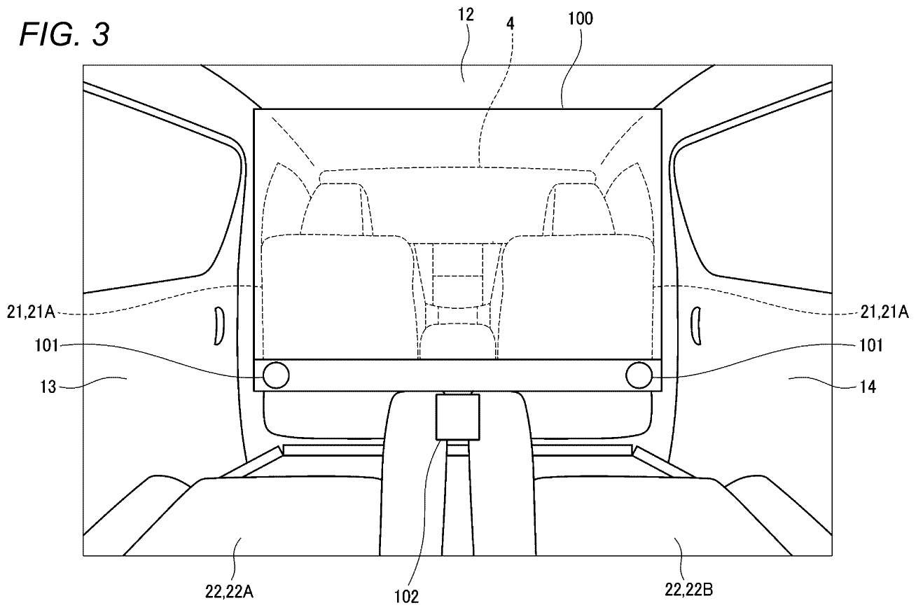

FIG. 1 is a plan view illustrating a configuration example of a vehicle 1 according to Embodiment 1, as seen through inside of the vehicle from above. FIG. 2 is a side view illustrating the configuration example of the vehicle 1 according to Embodiment 1, as seen through inside of the vehicle from a side. FIG. 3 is a diagram illustrating the configuration example of the vehicle 1 according to Embodiment 1, as seen forward from a rear seat 22 inside the vehicle. Next, the configuration of the vehicle 1 will be described with reference to FIGS. 1, 2, and 3.

For convenience of description, as illustrated in FIGS. 1 and 2, an entire length direction of the vehicle 1 is defined as a Y axis, a width direction of the vehicle 1 is defined as an X axis, and a height direction of the vehicle 1 is defined as a Z axis. For convenience of description, a positive direction of the Z axis may be referred to as “upper”, a negative direction of the Z axis may be referred to as “lower”, a positive direction of the Y axis may be referred to as “front”, a negative direction of the Y axis may be referred to as “rear”, a positive direction of the X axis may be referred to as “right”, and a negative direction of the X axis may be referred to as “left”. Expressions related to these directions are used for convenience of description, and are not intended to limit a posture of the structure in actual use.

The vehicle 1 includes at least a vehicle body 2, a first wheel 3A, a second wheel 3B, a third wheel 3C, and a fourth wheel 3D that are coupled to the vehicle body 2, and is capable of traveling in a predetermined direction (for example, a direction of the Y axis) using the first wheel 3A, the second wheel 3B, the third wheel 3C, and the fourth wheel 3D. However, the vehicle 1 is not limited to the configuration including four wheels, and may be a configuration including two or three wheels or five or more wheels. The vehicle 1 may be a private car, a commercial car, a taxi, a truck, a bus, or the like.

The vehicle body 2 includes a floor surface portion 11 and a ceiling surface portion 12 disposed along a predetermined direction.

The vehicle body 2 includes a left side surface portion 13 connecting the floor surface portion 11 and the ceiling surface portion 12 and disposed on a left side surface along a predetermined direction, and a right side surface portion 14 connecting the floor surface portion 11 and the ceiling surface portion 12 and disposed on a right side surface along a predetermined direction.

The vehicle body 2 includes a front surface portion 16 connecting the floor surface portion 11 and the ceiling surface portion 12 and disposed in a front portion 15 along a predetermined direction, and a rear surface portion 18 connecting the floor surface portion 11 and the ceiling surface portion 12 and disposed in a rear portion 17 along a predetermined direction.

The vehicle body 2 includes at least one front seat 21 disposed closer to a front surface portion 16 side than the rear surface portion 18 on the floor surface portion 11, and at least one rear seat 22 disposed closer to a rear surface portion 18 side than the front surface portion 16 on the floor surface portion 11.

The front surface portion 16 includes a front window 4 made of glass that allows an outside of the vehicle to be visually recognized from the front seat 21 in a predetermined direction.

The vehicle body 2 further includes a rectangular transparent display 100 between the rear seat 22 and the front seat 21. The display 100 can change a light transmittance. Examples of the display 100 include an organic EL display and an LED display. For example, the display 100 has a configuration in which a liquid crystal shutter capable of controlling a light transmittance is disposed to overlap a self-luminous display panel (for example, an organic EL panel) having translucency. The display 100 brings, close to 100%, the light transmittance of a liquid crystal shutter corresponding to a region desired to be close to transparency, and brings, close to 0%, the light transmittance of a liquid crystal shutter corresponding to a region desired to be close to light shielding. Accordingly, the display 100 can bring any region close to transparent or close to light shielding.

When the display 100 is in a transparent state, an occupant seated in the rear seat 22 can visually recognize the outside of the vehicle through the display 100 and the front window 4.

The display 100 is set to play a predetermined video. In the present embodiment, the video is described as a moving image, and the video may be a still image.

The vehicle 1 includes speakers 101 in a rear chamber inside the vehicle. As illustrated in FIG. 3, the speakers 101 may be installed below the display 100. However, the speakers 101 may be installed at any position.

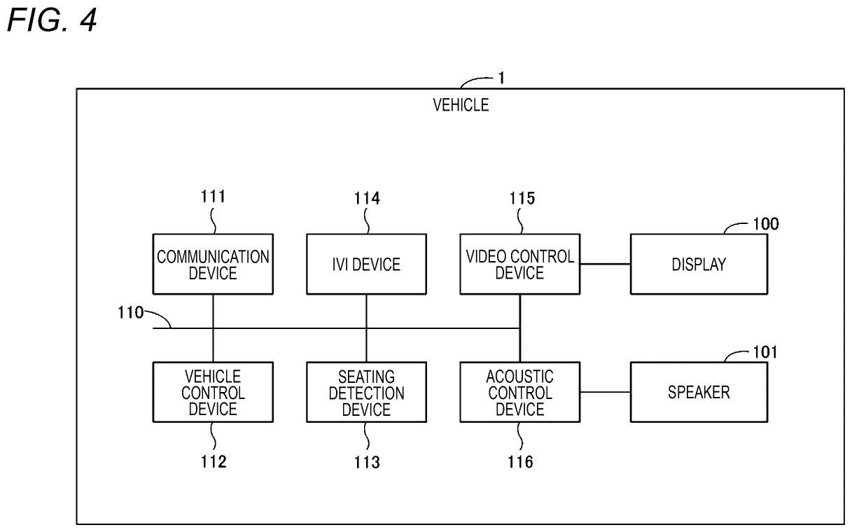

The vehicle 1 includes an operation unit 102 near the rear seat 22 inside the vehicle. The operation unit 102 may be a tablet terminal installed inside the vehicle. Alternatively, the operation unit 102 may connect a smartphone carried by the occupant to the vehicle 1 in a wired or wireless manner. Alternatively, the operation unit 102 may be a remote controller for operating an IVI device 114 (see FIG. 4). Details of operations that the occupant can perform through the operation unit 109 will be described later.

As illustrated in FIG. 3, the occupant in the rear seat 22 can view the video displayed on the display 100. However, the occupant in the rear seat 22 who views the video displayed on the entire surface of the display 100 tends to easily get car sickness when the behavior of the vehicle 1 is large (for example, when acceleration/deceleration or the acceleration of the vehicle 1 due to turning is large) because a front field of view outside the vehicle is blocked by the video. Therefore, in the present embodiment, a technique for preventing car sickness of the occupant in the rear seat 22 by appropriately controlling a display mode of a video on the display 100 will be described.

### <Configuration of Device>

FIG. 4 is a block diagram illustrating an example of a device provided in the vehicle 1 according to Embodiment 1.

As illustrated in FIG. 4, the vehicle 1 includes a communication device 111, a vehicle control device 112, a seating detection device 113, the IVI device 114, a video control device 115, an acoustic control device 116, the display 100, and the speakers 101.

The communication device 111, the vehicle control device 112, the seating detection device 113, the IVI device 114, the video control device 115, and the acoustic control device 116 can transmit and receive information to and from each other via the in-vehicle network 110. Examples of the in-vehicle network 110 include Controller Area Network (CAN), Local Interconnect Network (LIN), and FlexRay.

The communication device 111 is a device that performs wireless communication with an external device (for example, a server) through a predetermined communication network. Examples of the communication network include a mobile communication network (for example, LTE, 4G, 5G, and 6G), Wi-Fi (registered trademark), and Bluetooth (registered trademark).

The vehicle control device 112 is a device that controls a behavior of the vehicle 1. For example, the vehicle control device 112 controls start and stop, acceleration and deceleration, turning, and the like of the vehicle 1. Further, the vehicle control device 112 provides information indicating situations such as start and stop, acceleration and deceleration, and turning.

The seating detection device 113 is a device for detecting whether an occupant is seated in each seat. For example, the seating detection device 113 may detect whether an occupant is seated in a seat by a weight sensor provided in the seat. Alternatively, the seating detection device 113 may detect whether an occupant is seated in a seat based on whether a seat belt of the seat is fastened. Alternatively, the seating detection device 113 may detect whether an occupant is seated in a seat by performing a person detection process at a position of the seat from an image captured by a camera installed inside the vehicle.

The IVI device 114 is a device that provides information related to the vehicle 1 and provides entertainment. IVI is an abbreviation for “in-vehicle infotainment”. For example, the IVI device 114 outputs a music and a video, such as car audio, in-vehicle DVD, TV tuner, radio, and VOD. The IVI device 114 may be read as a control unit or an electronic control unit (ECU). The IVI device 114 may include a processor and a memory.

The IVI device 114 searches for and outputs a route to a destination. The IVI device 114 may search for a route to a destination using built-in map data, or may cause an external device to search for a route to a destination via the communication device 111 and acquire and output the search result. The route to the destination may be displayed as a navigation for a driver or may be used as an autonomous driving plan of the vehicle 1.

The IVI device 114 controls video display of the display 100 in cooperation with the video control device 115. Details of a method of controlling the video display will be described later. The IVI device 114 controls an acoustic output of each speaker 101 in cooperation with the acoustic control device 116. Details of a method of controlling the acoustic output will be described later.

The video control device 115 controls video display of the display 100. The video may be either a still image or a moving image. In addition, the video control device 115 can control the light transmittance in any region of the display 100. The video control device 115 may control the display of the video on the display 100 and the transmittance in any region under the control of the IVI device 114. The video control device 115 and the display 100 may be included in a display device. Alternatively, the IVI device 114, the video control device 115, and the display 100 may be included in the display device.

The acoustic control device 116 controls the acoustic output of each speaker 101. The acoustic control device 116 may control the acoustic output to the speaker 101 under the control of the IVI device 114.

### <First Display Mode>

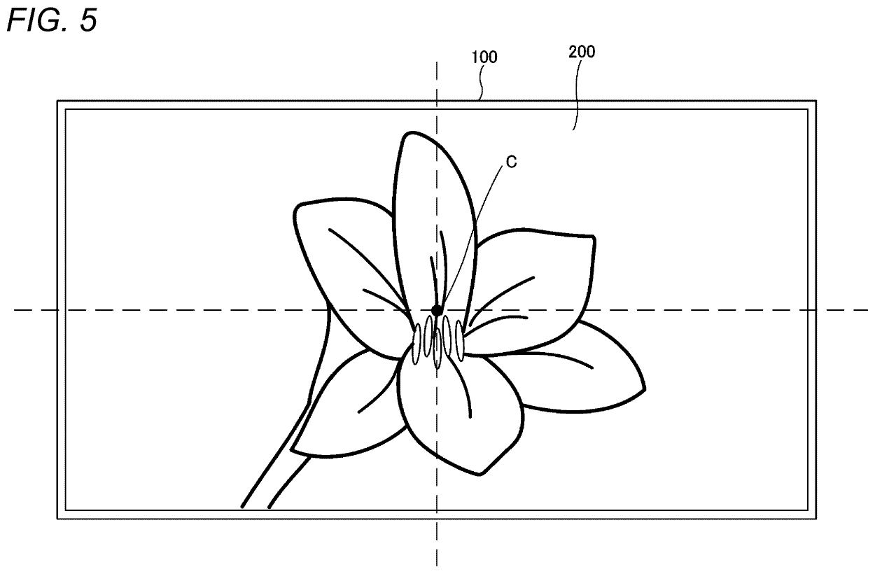

FIG. 5 is a diagram illustrating an example of displaying a video in a first display mode on the display 100 according to Embodiment 1.

As illustrated in FIG. 5, as a first display mode, the display 100 displays the video 200 such that a center of a video 200 is disposed at a first position and a size of the video 200 is a first size. The first position may be a center C of the display 100. The first display mode may be selected if a first condition is satisfied.

The first condition may be that the acceleration of the vehicle 1 in a predetermined direction is a first magnitude. The first magnitude of the acceleration in the predetermined direction may be a magnitude of a time average over a predetermined time. The predetermined direction may be at least one of a left-right direction (X-axis direction) of the vehicle 1, an up-down direction (Z-axis direction) of the vehicle 1, or a front-rear direction (Y-axis direction) of the vehicle 1.

For example, when the time average of the predetermined time of the acceleration applied in any of the left-right direction, the up-down direction, and the front-rear direction of the vehicle 1 is the first magnitude (for example, magnitude equal to or smaller than a threshold β), the display 100 displays the video 200 such that the center of the video 200 is at the first position and the size of the video 200 is the first size, assuming that the first condition is satisfied. The first position may be a position of the center C of the display 100, and the first size of the video 200 may be a maximum size in which the display 100 can display the video. However, the first position and the first size of the video 200 are not limited thereto.

In the first display mode, the display 100 may set a light transmittance of a display region of the video 200 to less than a predetermined threshold (for example, non-transmissive).

Accordingly, when the acceleration applied to any direction of the vehicle 1 is sufficiently small and the possibility that an occupant in the rear seat 22 gets car sickness is low, the occupant in the rear seat 22 can view the video 200 displayed in a large size on the display 100.

<second Display Mode>

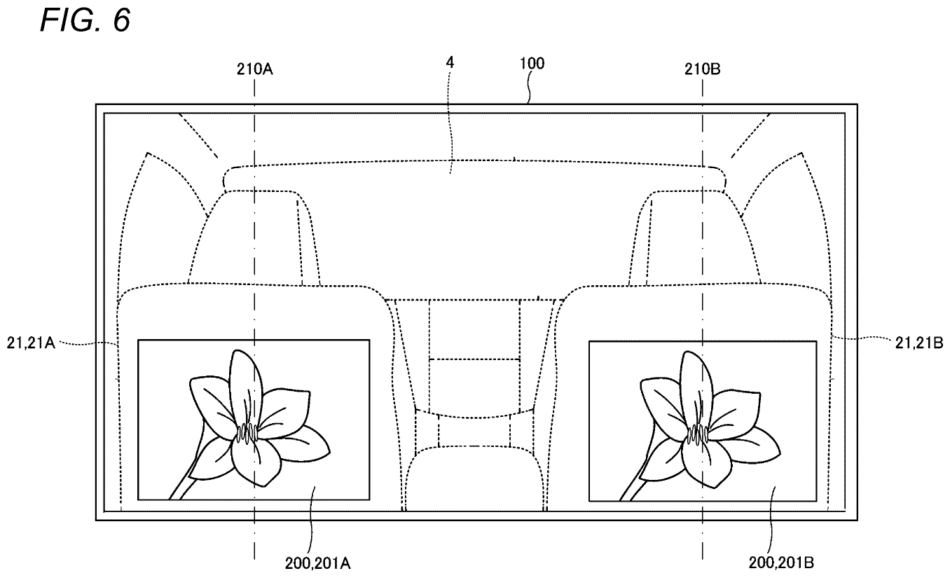

FIG. 6 is a diagram illustrating an example of displaying a video in a second display mode on the display 100 according to Embodiment 1.

As illustrated in FIG. 6, in a second display mode, the display 100 displays the video 200 such that the center of the video 200 is located at a second position and the size of the video 200 is a second size smaller than the first size. For example, an area of the video 200 having the second size may be ¼ times to 1/16 times an area of the video 200 having the first size. The second position may be on a left side or a right side of the first position. However, in the second display mode, the second position may be the same as the first position. The second display mode may be selected if a second condition different from the first condition is satisfied.

In addition, as a second display mode, the display 100 may display a video such that a center of the video 200 is disposed at a third position and a size of the video 200 is a third size smaller than the first size. For example, an area of the video 200 having the third size may be ¼ times to 1/16 times an area of the video 200. When the second position is on the left side of the first position, the third position may be on the right side of the first position. When the second position is on the right side of the first position, the third position may be on the left side of the first position. The second position and/or the third position may be lower than the first position.

The second position (or the third position) may be determined corresponding to a seating position of an occupant on the rear seat 22. The seating position of the occupant is detected by the seating detection device 113. The seating detection device 113 may be read as a seating position detection circuit.

The second condition may be that the acceleration of the vehicle 1 in a predetermined direction is a second magnitude greater than the first magnitude. The second magnitude of the acceleration in the predetermined direction may be a magnitude of a time average over a predetermined time. The predetermined direction may be at least one of a left-right direction (X-axis direction) of the vehicle 1, an up-down direction (Z-axis direction) of the vehicle, or a front-rear direction (Y-axis direction) of the vehicle. The second condition may be a case where a route along which the vehicle 1 is scheduled to travel satisfies a specific condition.

For example, when the time average of the predetermined time of the acceleration applied in any of the left-right direction, the up-down direction, and the front-rear direction of the vehicle 1 is a second magnitude greater than the first magnitude, the display 100 displays the video 200 in which the center of the video 200 is at the second position and the size of the video 200 is a second size and/or the video 200 in which the center of the video 200 is at the third position and the size of the video 200 is the third size, assuming that the second condition is satisfied. The second position may be a lower left position of the display 100, and the third position may be a lower right position of the display 100. Alternatively, the second position may be a lower right position of the display 100, and the third position may be a lower left position of the display 100. In addition, the video 200 having the second size and the video 200 having the third size are smaller than the video 200 having the first size, and thus may be referred to as reduced videos in the present embodiment.

When it is detected that an occupant is seated in the left rear seat 22A, the display 100 may display a reduced video 201A at a lower left position. For example, the display 100 may display the reduced video 201A such that a central axis 210A (one-dot chain line) of a width (width in the X-axis direction) of the left rear seat 22A is a central axis of a width of the reduced video 201A.

When it is detected that an occupant is seated in the right rear seat 22B, the display 100 displays a reduced video 201B at a lower right position. For example, the display 100 may display the reduced video 201B such that a central axis 210B (one-dot chain line) of a width (width in the X-axis direction) of the right rear seat 22B is a central axis of a width of the reduced video 201B.

In the display 100, as the second display mode, the light transmittance of a region in which the reduced video 201A and/or the reduced video 201B is not displayed may be higher (for example, transparent) than the light transmittance of a region in which the reduced video 201A and/or the reduced video 201B is displayed.

Accordingly, since the degree of acceleration applied to any of the directions of the vehicle 1 is considerably large, when there is a high possibility that the occupant in the rear seat 22 gets car sickness, the occupant in the rear seat 22 can view the reduced video 201A and/or the reduced video 201B displayed on the display 100 while facing forward. Therefore, the occupant is less likely to get car sickness than in the first display mode. In addition, since the region of the display 100 in which the reduced video 201A and/or the reduced video 201B is not displayed is transparent, the occupant in the rear seat 22 does not block the front field of view outside the vehicle (that is, the occupant can see the front scene through the front window 4). Therefore, the occupant is less likely to get car sickness than in the first display mode.

The reduced video 201A displayed at the lower left position of the display 100 may be reduced to be superimposed on the left front seat 21A. Similarly, the reduced video 201B displayed at the lower right position of the display 100 may be reduced to be superimposed on the right front seat 21B. As a result, the occupant in the rear seat 22 can see the forward scenery through the front window 4 and a transparent region of the display 100 that does not overlap the front seat 21, so that the occupant is less likely to get car sickness.

If the second condition is satisfied, the display 100 may display information indicating that the video is intentionally reduced when switching to the second display mode. Accordingly, the occupant in the rear seat 22 can know the reason why the video 200 is reduced.

### <Third Display Mode>

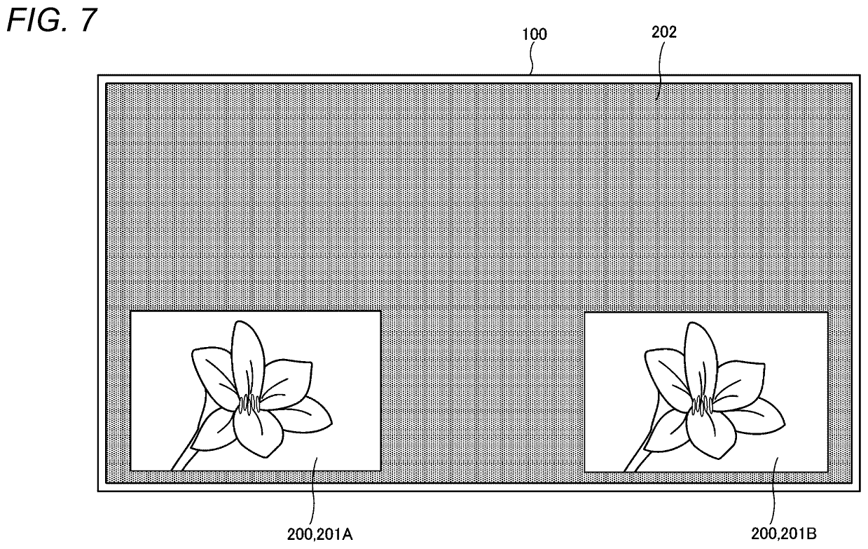

FIG. 7 is a diagram illustrating an example of displaying a video in a third display mode on the display 100 according to Embodiment 1.

As illustrated in FIG. 7, as a third display mode, the display 100 displays the video 200 in the same manner as in the second display mode described above, and a region where the video 200 is not displayed is not transparent and is an image (hereinafter, referred to as a background image 202) having a predetermined color tone and/or luminance. The predetermined color tone may be an average color tone of all pixels of the video 200. The predetermined luminance may be an average luminance of all pixels of the video 200.

The third display mode may be selected if a third condition different from the first condition or the second condition is satisfied. The third condition may be that the acceleration of the vehicle 1 in a predetermined direction is a third magnitude between the first magnitude and the second magnitude. The third magnitude of the acceleration in the predetermined direction may be a magnitude of a time average over a predetermined time. The predetermined direction may be at least one of the left-right direction of the vehicle 1, the up-down direction of the vehicle 1, or the front-rear direction of the vehicle 1.

For example, when the time average of the acceleration applied to the vehicle 1 is the third magnitude between the first magnitude and the second magnitude, the display 100 displays the video 200 in which the center of the video 200 is at the second position and the size of the video 200 is the second size and/or the video 200 in which the center of the video 200 is at the third position and the size of the video 200 is the third size, assuming that the third condition is satisfied. Further, the display 100 displays the background image 202 having a color tone and/or luminance suitable for the video 200 in a region where the video 200 is not displayed.

Accordingly, since the degree of acceleration applied to any of the directions of the vehicle 1 is considerably large, when the possibility of car sickness of the occupant in the rear seat 22 is medium, the occupant in the rear seat 22 can view the reduced video 201A and/or the reduced video 201B displayed on the display 100 while facing forward. Therefore, the occupant is less likely to get car sickness than in the first display mode. Since the background image 202 having a color tone and/or luminance suitable for the video 200 is displayed in a region of the display 100 where the reduced video 201A and/or the reduced video 201B is not displayed, it is possible to enhance a sense of immersion in the video 200 of the occupant in the rear seat 22 as compared with the second display mode.

The vehicle 1 does not necessarily need to implement all of the first display mode, the second display mode, and the third display mode, and may implement at least one of the first display mode, the second display mode, and the third display mode.

### <Change in Size and the Like of Video>

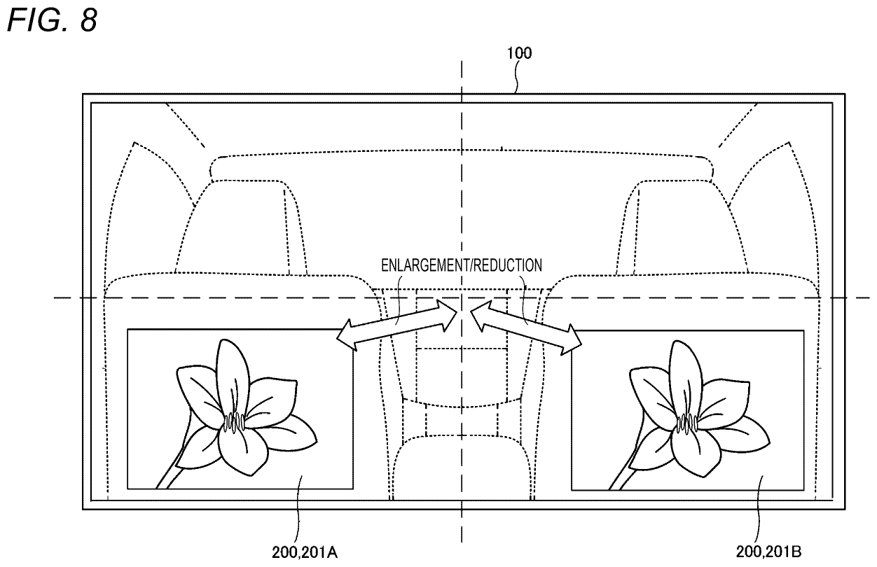

FIG. 8 is a diagram illustrating a case where an occupant instructs to change a display mode of the video 200 according to Embodiment 1.

The occupant can switch between display and non-display of the video 200, change the display positions of the video 200 in the up-down direction and the right-left direction, change a display size of the video 200, or the like through the operation unit 109.

For example, when the second display mode or the third display mode is selected, the occupant in the left rear seat 22A can enlarge the reduced video 201A displayed at a lower left position to half a width of the display 100 while maintaining an aspect ratio.

For example, when the second display mode or the third display mode is selected, the occupant in the right rear seat 22B can enlarge the reduced video 201B displayed at a lower right position to half a width of the display 100 while maintaining an aspect ratio.

### <Process Flow>

Next, a method of switching the first display mode, the second display mode, and the third display mode will be described.

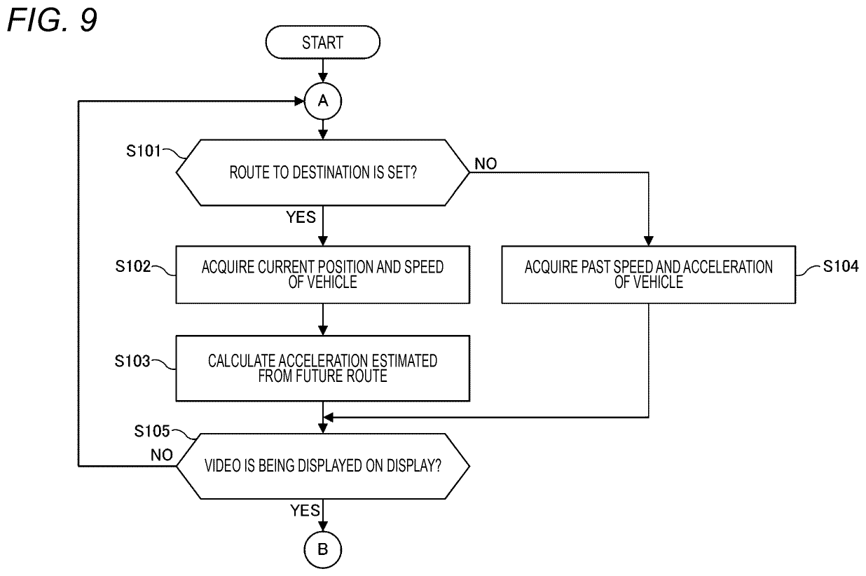

FIG. 9 is a flowchart illustrating an example of a display process according to Embodiment 1.

The IVI device 114 determines whether a route to a destination is set (S101).

If the route to the destination is set (S101: YES), the IVI device 114 acquires a current position and speed of the vehicle 1 (S102). The current position of the vehicle 1 may be measured by Global Navigation Satellite Systems (GNSS). The current speed of the vehicle 1 may be provided from the vehicle control device 112. The IVI device 114 calculates the acceleration predicted to be applied to the vehicle 1 in a future constant period from the position and the speed acquired in step S101 and the future route (S103). Then, the process proceeds to step S105.

If the route to the destination is not set (S101: NO), the IVI device 114 acquires the speed and/or the acceleration (that is, the past history) of the vehicle 1 in a past certain period (S104). Then, the process proceeds to step S105.

The IVI device 114 determines whether the video 200 is being displayed on the display 100 (S105).

When the video 200 is not being displayed on the display 100 (S105: NO), the process returns to step S101.

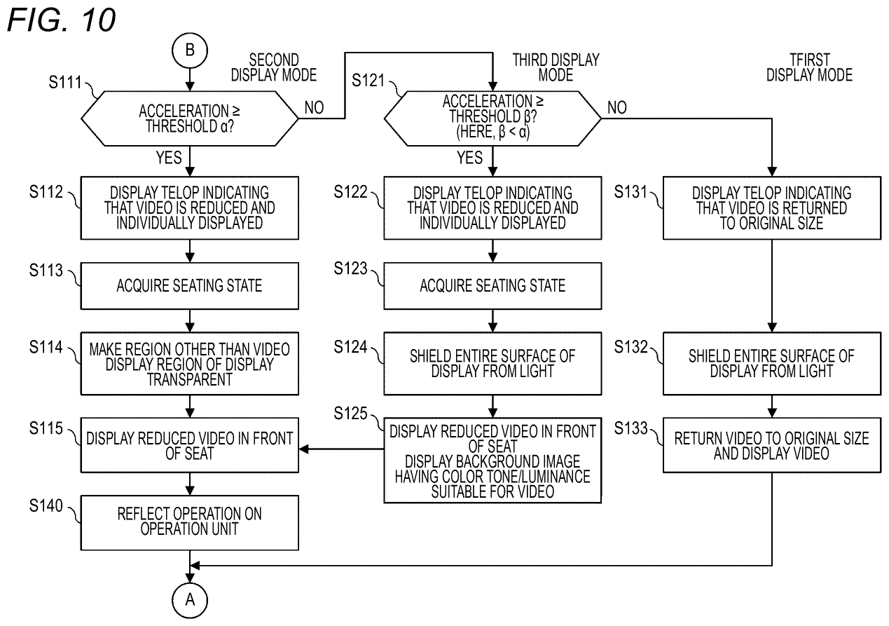

When the video 200 is being displayed on the display 100 (S105: YES), the process proceeds to step B illustrated in FIG. 10 to be described later.

FIG. 10 is a flowchart illustrating processes following the display process illustrated in FIG. 9.

The IVI device 114 determines whether an average acceleration in a future certain period calculated in step S103 in FIG. 9 or an average acceleration in a past certain period acquired in step S104 in FIG. 9 is greater than the threshold α (that is, whether the average acceleration is the first magnitude) (S111). That is, it is determined whether a considerably large acceleration is predicted to be applied to the vehicle 1 for a certain period from the future route.

Next, a case where it is determined that the acceleration is larger than the threshold α (S111: YES) will be described. In this case, the IVI device 114 selects the above-described second display mode and performs, for example, the following process.

The IVI device 114 displays a telop indicating that the video is reduced and displayed individually on the display 100 (S112). Instead of the display by the telop, or together with the display by the telop, the IVI device 114 may output the fact by voice from the speaker 101.

The IVI device 114 acquires a seating state of the rear seat 22 through the seating detection device 113 (S113). That is, the IVI device 114 detects the rear seat 22 on which an occupant is seated.

The IVI device 114 controls the display 100 through the video control device 115 so that a region other than a region where the video 200 is displayed becomes transparent (that is, a predetermined transmittance or more) (S114).

The IVI device 114 displays, on the display 100 through the video control device 115, the reduced video 201A and/or the reduced video 201B at a position in front of the rear seat 22 on which the occupant is seated (S115). For example, the IVI device 114 displays the reduced video 201A at a lower left position of the display 100 when an occupant is seated in the left rear seat 22A, and displays the reduced video 201B at a lower right position of the display 100 when an occupant is seated in the right rear seat 22B.

Accordingly, since the video 200 is displayed on the display 100 in the second display mode described above, it is possible to prevent car sickness of the occupant in the rear seat 22 when a considerably large acceleration is applied to the vehicle 1 in the future route.

When the occupant operates the operation unit 102, the IVI device 114 changes the display of the reduced video 201A and/or the reduced video 201B based on the operation content (S140). For example, the reduced video 201A and/or the reduced video 201B are enlarged or reduced, display positions of the reduced video 201A and/or the reduced video 201B are changed, or the display or non-display of the reduced videos 201A and/or the reduced video 201B is changed. Then, the process returns to step A illustrated in FIG. 9.

Next, a case where the acceleration is equal to or less than the threshold α (S111: NO) will be described.

The IVI device 114 determines whether the average acceleration in the future certain period calculated in step S103 in FIG. 9 or the average acceleration in the past certain period acquired in step S104 in FIG. 9 is greater than the threshold value β (where β<α) (that is, whether the acceleration is the third magnitude) (S121). That is, it is determined whether it is predicted that a medium acceleration is applied to the vehicle 1 for a certain period from a future route.

Next, a case where it is determined that the acceleration is larger than the threshold value β (S121: YES) will be described. In this case, the IVI device 114 selects the above-described third display mode and performs, for example, the following process.

The IVI device 114 displays a telop indicating that the video is reduced and individually displayed on the display 100 (S122). Instead of the display by the telop, or together with the display by the telop, the IVI device 114 may output the fact by voice from the speaker 101.

The IVI device 114 acquires the seating state of the rear seat 22 through the seating detection device 113 (S123).

The IVI device 114 controls the display 100 through the video control device 115 so that the entire surface is shielded from light (that is, less than a predetermined transmittance) (S124).

The IVI device 114 displays, on the display 100 through the video control device 115, the reduced video 201A and/or 201B at a position in front of the rear seat 22 on which the occupant is seated. In addition, the IVI device 114 displays the background image 202 having a color tone and/or luminance suitable for the video 200 on the display 100 through the video control device 115 (S125). Then, the process proceeds to step S115 described above.

Accordingly, since the video 200 is displayed on the display 100 in the third display mode described above, it is possible to achieve both preventing of car sickness of the occupant in the rear seat 22 and a sense of immersion in the video 200 in a case where the medium acceleration is applied to the vehicle 1 in the future route.

Next, a case where it is determined that the average acceleration is equal to or smaller than the threshold β (S121: NO) will be described. In this case, the IVI device 114 selects the above-described first display mode and performs, for example, the following process.

The IVI device 114 displays, on the display 100, a telop indicating that the video is returned to an original size (for example, a maximum size) (S131). Instead of the display by the telop, or together with the display by the telop, the IVI device 114 may output the fact by voice from the speaker 101.

The IVI device 114 controls the display 100 through the video control device 115 so that the entire surface is shielded from light (that is, less than a predetermined transmittance) (S132).

The IVI device 114 returns the video 200 to the original size (for example, the maximum size) and displays the video 200 on the display 100 through the video control device 115 (S133). Then, the process returns to step A illustrated in FIG. 9.

Accordingly, since the video 200 is displayed on the display 100 in the first display mode described above, it is possible to enhance the sense of immersion of the video 200 of the occupant in the rear seat 22 in a case where the acceleration applied to the vehicle 1 in the future route is sufficiently small.

Some of the processes illustrated in FIGS. 9 and 10 may be omitted. For example, steps S121 to S125 may be omitted. In this case, when the determination result in step S111 is NO, the process may proceed to step S131.

### Example of Change in Acceleration and Change in Display Mode

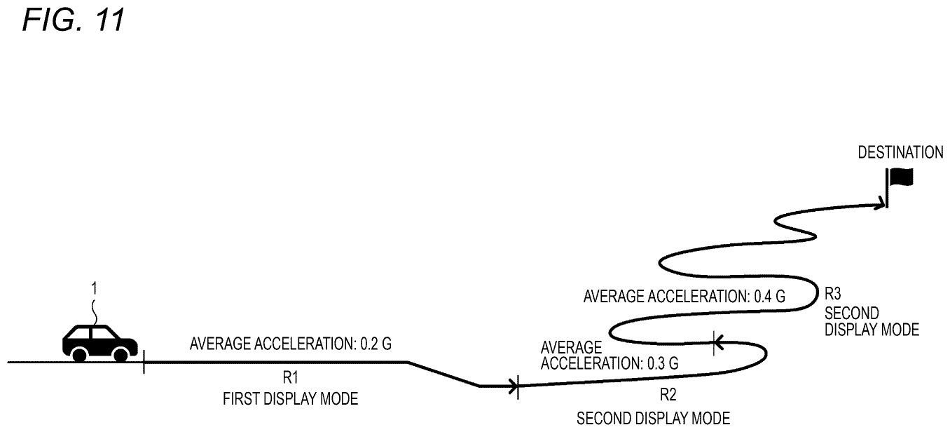

FIG. 11 is a diagram illustrating an example of a change in acceleration of the vehicle 1 and a change in display mode of the display 100 according to Embodiment 1.

For example, it is assumed that a route as illustrated in FIG. 11 is set for the vehicle 1.

The IVI device 114 predicts that the vehicle 1 will travel along the route R1 in the future, and selects the first display mode in a case where the IVI device 114 estimates that the average acceleration in a certain period T1 in which the vehicle 1 travels along the route R1 is 0.2 G (acceleration 0.2 G<threshold β). Accordingly, the occupant in the rear seat 22 can view the video 200 displayed in a large size on the display 100 in the certain period T1 in which the acceleration is relatively low and the possibility of car sickness is relatively low. That is, the display 100 can provide the video 200 with a high sense of immersion.

The vehicle 1 further proceeds, and the IVI device 114 predicts that the vehicle 1 will travel along a route R2 in the future, and selects the third display mode when it is estimated that the average acceleration is 0.3 G (threshold β≤acceleration 0.3 G<threshold α) in a certain period T2 in which the vehicle 1 travels along the route R2. Accordingly, the occupant in the rear seat 22 can view the reduced video 201A and/or the reduced video 201B facing forward while feeling the background image 202 having a color tone and/or luminance suitable for the video 200 in the certain period T2 in which the possibility of car sickness is medium because the acceleration is medium. That is, the display 100 can achieve both preventing of car sickness and a sense of immersion in video viewing.

The vehicle 1 further proceeds, and the IVI device 114 predicts that the vehicle 1 will travel along the route R3 in the future, and selects the second display mode when it is estimated that the average acceleration is 0.4 G (acceleration degree 0.4 G≥threshold α) in a certain period T3 in which the vehicle 1 travels along the route R3. Accordingly, since the acceleration is relatively high, the occupant in the rear seat 22 can view the reduced video 201A and/or the reduced video 201B facing forward while feeling the scenery outside the vehicle from a transparent region of the display 100 in the certain period T3 in which the possibility of car sickness is relatively high. That is, the display 100 can achieve both preventing of car sickness and provision of video viewing.

The IVI device 114 may calculate a predicted value of the average acceleration in each section of a route based on a traffic light and a temporary stop line installed on the route, a curvature radius of a curve of the route, a legal speed in the route, and/or traveling characteristics of the vehicle 1. In addition, by adopting the average acceleration, it is possible to prevent the condition from being frequently changed according to a fine change in the acceleration.

### Summary of Embodiment 1

The following techniques are disclosed from the above description of Embodiment 1.

### <Technique A1>

The vehicle 1 includes at least the first wheel 3A coupled to the vehicle body 2, the second wheel 3B coupled to the vehicle body 2, the third wheel 3C coupled to the vehicle body 2, and the fourth wheel 3D coupled to the vehicle body 2, and is capable of traveling in a predetermined direction using the first wheel 3A, the second wheel 3B, the third wheel 3C, and the fourth wheel 3D.

The vehicle body 2 includes: the floor surface portion 11 and the ceiling surface portion 12 disposed along a predetermined direction; the left side surface portion 13 connecting the floor surface portion 11 and the ceiling surface portion 12 and disposed on the left side surface along a predetermined direction; the right side surface portion 14 connecting the floor surface portion 11 and the ceiling surface portion 12 and disposed on the right side surface along a predetermined direction; the front surface portion 16 connecting the floor surface portion 11 and the ceiling surface portion 12 and disposed in the front portion 15 along a predetermined direction; the rear surface portion 18 connecting the floor surface portion 11 and the ceiling surface portion 12 and disposed in the rear portion 17 along a predetermined direction; at least one front seat 21 disposed closer to the front surface portion 16 side than the rear surface portion 18 on the floor surface portion 11; at least one rear seat 22 disposed closer to the rear surface portion 18 side than the front surface portion 16 on the floor surface portion 11; and the display 100 disposed between the rear seat 22 and the front seat 21.

As the vehicle control method in the vehicle 1, if the first condition is satisfied, the display 100 displays the video 200 in a first size with a video center at a first position, and if a second condition different from the first condition is satisfied, the display 100 displays the video 200 (for example, the reduced video 201A and/or the reduced video 201B) in a second size smaller than the first size with a video center at a second position.

Accordingly, the display 100 can display the video in an appropriate mode according to the condition, and can view the video of the occupant in the rear seat 22 and prevent car sickness.

<technique A2>

In the vehicle control method according to technique A1, the second position is on a left side of the first position, or the second position is on a right side of the first position.

Accordingly, if the second condition is satisfied, the video is displayed at a position on the left side or the right side of the first position, and thus the occupant in the rear seat 22 can view the video while further facing more forward. Therefore, car sickness of the occupant in the rear seat 22 can be further prevented.

### <Technique A3>

In the vehicle control method according to technique A1 or A2, the first condition is that acceleration of the vehicle 1 in a predetermined direction is a first magnitude, and the second condition is that acceleration of the vehicle 1 in the predetermined direction is a second magnitude greater than the first magnitude.

Accordingly, if the second condition that is more likely to cause car sickness is satisfied, a video smaller than that if the first condition is satisfied is displayed on the display 100, and thus car sickness of the occupant in the rear seat 22 can be further prevented.

### <Technique A4>

In the vehicle control method according to technique A3, the first magnitude of the acceleration in the predetermined direction is a magnitude of a time average over a predetermined time, and the second magnitude of the acceleration in the predetermined direction is a magnitude of a time average over the predetermined time.

By adopting the average acceleration of the predetermined time, it is possible to prevent the condition from being frequently changed according to a fine change in the acceleration.

<technique A5>

In the vehicle control method according to technique A3 or A4, the predetermined direction is at least one of a left-right direction of the vehicle 1, an up-down direction of the vehicle 1, or a front-rear direction of the vehicle 1.

Accordingly, the conditions are appropriately switched according to changes in the acceleration of the vehicle 1 in various directions.

### <Technique A6>

In the vehicle control method according to any one of techniques A1 to A5, if the first condition is satisfied, the display 100 displays the video 200 in the first size with the video center at the first position, then, if the second condition is satisfied, the display 100 displays the video 200 in the second size with the video center at the second position, and then, if the first condition is satisfied, the display 100 displays the video 200 in the first size with the video center at the first position.

Accordingly, the display 100 can display the video 200 in an appropriate mode according to the condition, and can view the video of the occupant in the rear seat 22 and prevent car sickness.

### <Technique A7>

In the vehicle control method according to any one of techniques A1 to A6, if the second condition is satisfied, the display 100 displays the video 200 in the second size smaller than the first size with the video center at the second position, and displays the video 200 in a third size smaller than the first size with the video center at a third position, and the second position is on a left side of the first position and the third position is on a right side of the first position.

Accordingly, if the second condition that is likely to cause car sickness is satisfied, a video smaller than that if the first condition is satisfied is displayed on the display 100, and thus car sickness of the occupant in the rear seat 22 can be further prevented.

### <Technique A8>

In the vehicle control method according to any one of techniques A1 to A7, the vehicle 1 includes a seating position detection circuit (for example, the seating detection device 113) that detects a seating position of an occupant in the rear seat 22, and the second position corresponds to the seating position of the occupant.

Accordingly, since the video is displayed at the second position corresponding to the occupant seated in the rear seat 22, the occupant in the rear seat 22 can view the video while facing more forward. Therefore, car sickness of the occupant in the rear seat 22 can be further prevented.

<technique A9>

In the vehicle control method according to any one of techniques A1 to A8, the second position is lower than the first position.

Accordingly, the occupant in the rear seat 22 can view the video while facing more forward. Therefore, car sickness of the occupant in the rear seat 22 can be further prevented.

### <Technique A10>

In the vehicle control method according to any one of techniques A1 to A10, if the second condition is satisfied, the display 100 displays the video 200 in the second size with the video center at the second position, and displays information indicating that the video is intentionally reduced.

Accordingly, the occupant in the rear seat 22 can know the reason why the video is reduced.

### <Technique A11>

The vehicle 1 includes at least the first wheel 3A coupled to the vehicle body 2, the second wheel 2B coupled to the vehicle body 2, the third wheel 3C coupled to the vehicle body 2, and the fourth wheel 3D coupled to the vehicle body 2, and is capable of traveling in a predetermined direction using the first wheel 3A, the second wheel 3B, the third wheel 3C, and the fourth wheel 3D. The display device is set to be mounted on the vehicle 1.

The vehicle body 2 includes: the floor surface portion 11 and the ceiling surface portion 12 disposed along a predetermined direction; the left side surface portion 13 connecting the floor surface portion 11 and the ceiling surface portion 12 and disposed on the left side surface along a predetermined direction; the right side surface portion 14 connecting the floor surface portion 11 and the ceiling surface portion 12 and disposed on the right side surface along a predetermined direction; the front surface portion 16 connecting the floor surface portion 11 and the ceiling surface portion 12 and disposed in the front portion 15 along a predetermined direction; the rear surface portion 18 connecting the floor surface portion 11 and the ceiling surface portion 12 and disposed in the rear portion 17 along a predetermined direction; at least one front seat 21 disposed closer to the front surface portion 16 side than the rear surface portion 18 on the floor surface portion 11; at least one rear seat 22 disposed closer to the rear surface portion 18 side than the front surface portion 16 on the floor surface portion 11; and the display 100 disposed between the rear seat 22 and the front seat 21.

As the display device, if the first condition is satisfied, the display 100 displays the video 200 in a first size with a video center at a first position, and if a second condition different from the first condition is satisfied, the display 100 displays the video 200 (for example, the reduced video 201A and/or the reduced video 201B) in a second size smaller than the first size with a video center at a second position.

Accordingly, the display 100 can display the video in an appropriate mode according to the condition, and can view the video of the occupant in the rear seat 22 and prevent car sickness.

### <Technique A12>

In the display device according to technique A11, the second position is on a left side of the first position, or the second position is on a right side of the first position.

Accordingly, if the second condition is satisfied, the video is displayed at a position on the left side or the right side of the first position, and thus the occupant in the rear seat 22 can view the video while further facing forward. Therefore, car sickness of the occupant in the rear seat 22 can be further prevented.

<technique A13>

In the display device according to technique A11 or A12, the first condition of the vehicle is that acceleration in a predetermined direction is a first magnitude, and the second condition is that acceleration of the vehicle in the predetermined direction is a second magnitude greater than the first magnitude.

Accordingly, if the second condition that is more likely to cause car sickness is satisfied, a video smaller than that if the first condition is satisfied is displayed on the display 100, and thus car sickness of the occupant in the rear seat 22 can be further prevented.

### <Technique A14>

In the display device according to technique A13, the first magnitude of the acceleration in the predetermined direction is a magnitude of a time average over a predetermined time, and the second magnitude of the acceleration in the predetermined direction is a magnitude of a time average of the predetermined time.

By adopting the average acceleration of the predetermined time, it is possible to prevent the condition from being frequently changed according to a fine change in the acceleration.

<technique A15>

In the display device according to technique A13 or A14, the predetermined direction is at least one of a left-right direction of the vehicle 1, an up-down direction of the vehicle 1, or a front-rear direction of the vehicle 1.

Accordingly, the conditions are appropriately switched according to changes in the acceleration of the vehicle 1 in various directions.

<technique A16>

In the display device according to any one of techniques A11 to A15, if the first condition is satisfied, the display 100 displays the video 200 in the first size with the video center at the first position, then, if the second condition is satisfied, the display 100 displays the video 200 in the second size with the video center at the second position, and then, if the first condition is satisfied, the display 100 displays the video 200 in the first size with the video center at the first position.

Accordingly, the display 100 can display the video 200 in an appropriate mode according to the condition, and can view the video of the occupant in the rear seat 22 and prevent car sickness.

<technique A17>

In the display device according to any one of techniques A11 to A16, if the second condition is satisfied, the display 100 displays the video 200 in the second size smaller than the first size with the video center at the second position, and displays the video 200 in a third size smaller than the first size with the video center at a third position, and the second position is on a left side of the first position and the third position is on a right side of the first position.

Accordingly, if the second condition that is likely to cause car sickness is satisfied, a video smaller than that if the first condition is satisfied is displayed on the display 100, and thus car sickness of the occupant in the rear seat 22 can be further prevented.

### <Technique A18>

In the display device according to techniques A11 to A17, the vehicle 1 includes a seating position detection circuit (for example, the seating detection device 113) that detects a seating position of an occupant in the rear seat 22, and the second position corresponds to the seating position of the occupant.

Accordingly, since the video is displayed at the second position corresponding to the occupant seated in the rear seat 22, the occupant in the rear seat 22 can view the video while facing more forward. Therefore, car sickness of the occupant in the rear seat 22 can be further prevented.

### <Technique A19>

In the display device according to any one of techniques A11 to A18, the second position is lower than the first position.

Accordingly, the occupant in the rear seat 22 can view the video while facing more forward. Therefore, car sickness of the occupant in the rear seat 22 can be further prevented.

### <Technique A20>

In the display device according to any one of techniques A11 to A20, if the second condition is satisfied, the display 100 displays the video 200 in the second size with the video center at the second position, and displays information indicating that the video is intentionally reduced.

Accordingly, the occupant in the rear seat 22 can know the reason why the video is reduced.

### Embodiment 2

### <Background of Present Disclosure>

It is considered that a display is installed inside the vehicle so that an occupant in a rear seat of the vehicle can view a video or the like. When the occupant touches the display or applies weight to the display, the display may be contaminated or damaged. Therefore, it is desirable to prevent the occupant from touching the display as much as possible.

Patent Literature 3 discloses that a touch panel that detects contact is provided on a display, and a predetermined warning is displayed on the display when contact that does not correspond to a normal operation is detected. Patent Literature 2 discloses that a person approaching a display is face-recognized by a camera, and when the person is recognized as a person to be warned, a predetermined warning is displayed on the display.

In Patent Literature 3, the warning is displayed after the contact with the display, and the contact with the display cannot be prevented in advance. In Patent Literature 2, since a warning is displayed when a person approaches the display, the warning is unnecessarily displayed in a relatively narrow space such as the inside of the vehicle when a distance between the occupant and the display is normally short.

An object of the present disclosure is to provide a technique for preventing an occupant from touching a display installed inside a vehicle.

### <Configuration of Vehicle>

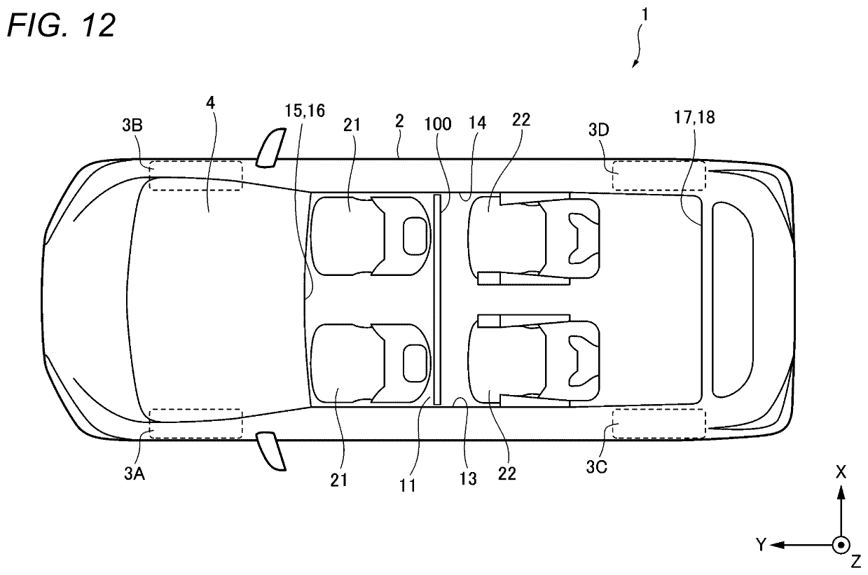

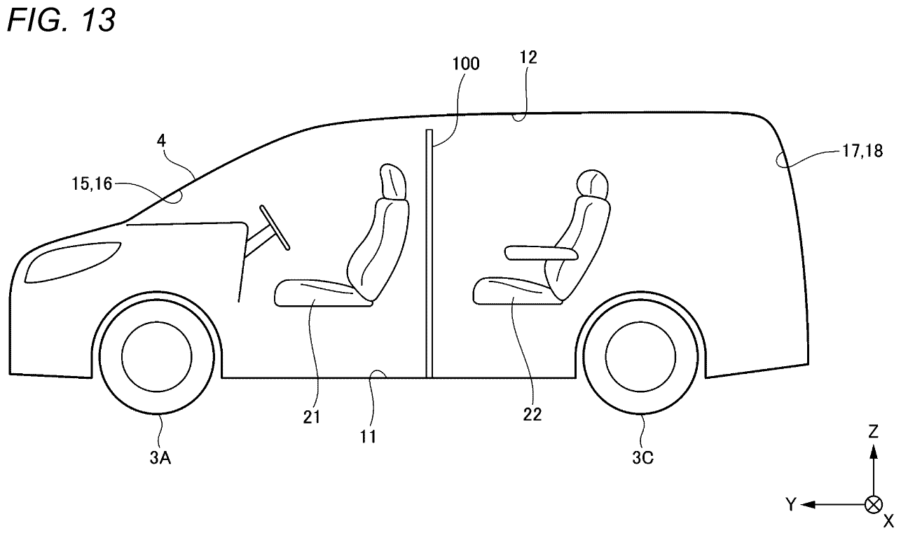

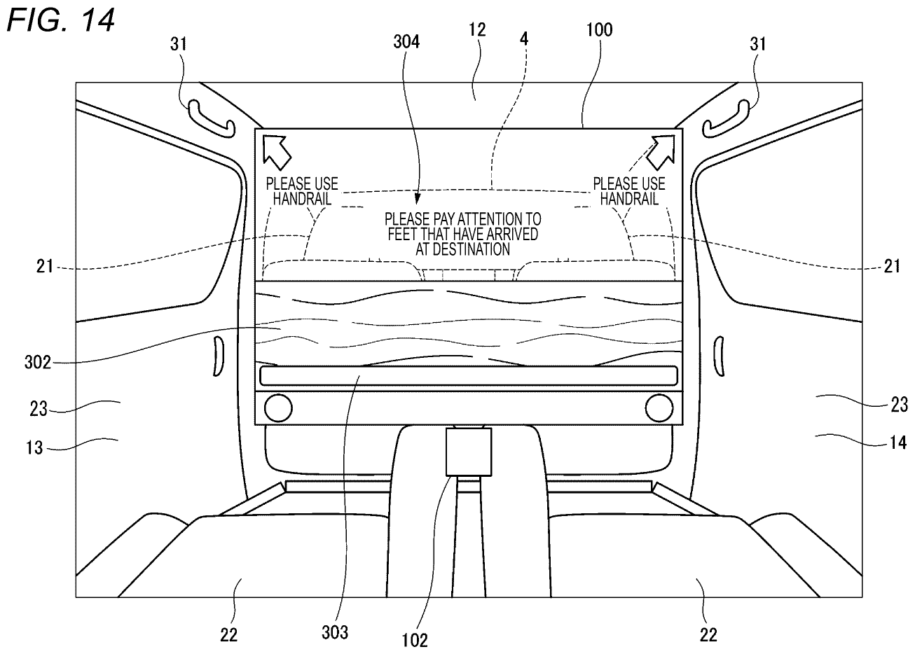

FIG. 12 is a plan view illustrating a configuration example of the vehicle 1 according to Embodiment 2, as seen through inside of the vehicle from above. FIG. 13 is a side view illustrating the configuration example of the vehicle 1 according to Embodiment 2, as seen through inside of the vehicle from the side. FIG. 14 is a diagram illustrating the configuration example of the vehicle 1 according to Embodiment 2, as seen forward from the rear seat 22 inside the vehicle. Next, the configuration of the vehicle 1 will be described with reference to FIGS. 12, 13, and 14.

For convenience of description, as illustrated in FIGS. 12 and 13, an entire length direction of the vehicle 1 is defined as a Y axis, a width direction of the vehicle 1 is defined as an X axis, and a height direction of the vehicle 1 is defined as a Z axis. For convenience of description, a positive direction of the Z axis may be referred to as “upper”, a negative direction of the Z axis may be referred to as “lower”, a positive direction of the Y axis may be referred to as “front”, a negative direction of the Y axis may be referred to as “rear”, a positive direction of the X axis may be referred to as “right”, and a negative direction of the X axis may be referred to as “left”. Expressions related to these directions are used for convenience of description, and are not intended to limit a posture of the structure in actual use.

The vehicle 1 includes at least the vehicle body 2 and the first wheel 3A, the second wheel 3B, the third wheel 3C, and the fourth wheel 3D coupled to the vehicle body 2, and is capable of traveling in a predetermined direction (for example, a direction of the Y axis) using the first wheel 3A, the second wheel 3B, the third wheel 3C, and the fourth wheel 3D. However, the vehicle 1 is not limited to the configuration including four wheels, and may be a configuration including two or three wheels or five or more wheels. The vehicle 1 may be a private car, a commercial car, a taxi, a truck, a bus, or the like.

The vehicle body 2 includes the floor surface portion 11 and the ceiling surface portion 12 disposed along the predetermined direction.

The vehicle body 2 includes the left side surface portion 13 connecting the floor surface portion 11 and the ceiling surface portion 12 and disposed on a left side surface along a predetermined direction, and the right side surface portion 14 connecting the floor surface portion 11 and the ceiling surface portion 12 and disposed on a right side surface along a predetermined direction.

The vehicle body 2 includes the front surface portion 16 connecting the floor surface portion 11 and the ceiling surface portion 12 and disposed in the front portion 15 along a predetermined direction, and the rear surface portion 18 connecting the floor surface portion 11 and the ceiling surface portion 12 and disposed in the rear portion 17 along a predetermined direction.

The vehicle body 2 includes at least one front seat 21 disposed closer to the front surface portion 16 side than the rear surface portion 18 on the floor surface portion 11, and at least one rear seat 22 disposed closer to the rear surface portion 18 side than the front surface portion 16 on the floor surface portion 11.

The front surface portion 16 includes the front window 4 made of glass that allows an outside of the vehicle to be visually recognized from the front seat 21 in a predetermined direction.

The vehicle body 2 further includes the rectangular transparent display 100 between the rear seat 22 and the front seat 21. The transparent display 100 can change the light transmittance in any region. Examples of the transparent display 100 include an organic EL display, an LED display, or the like. For example, the transparent display 100 has a configuration in which a liquid crystal shutter capable of controlling light transmittance is disposed to overlap a self-luminous display panel (for example, an organic EL panel) having translucency. The transparent display 100 brings, close to 100%, the light transmittance of a liquid crystal shutter corresponding to a region desired to be close to transparency, and brings, close to 0%, the light transmittance of a liquid crystal shutter corresponding to a region desired to be close to light shielding. Accordingly, the transparent display 100 can bring any region close to transparent or close to light shielding.

When the transparent display 100 is in a transparent state, an occupant seated in the rear seat 22 can visually recognize the outside of the vehicle through the transparent display 100 and the front window 4.

The transparent display 100 is set to reproduce predetermined content. The content may be either a moving image or a still image. In addition, the content may be read as a video. The occupant in the rear seat 22 can view the content displayed on the transparent display 100.

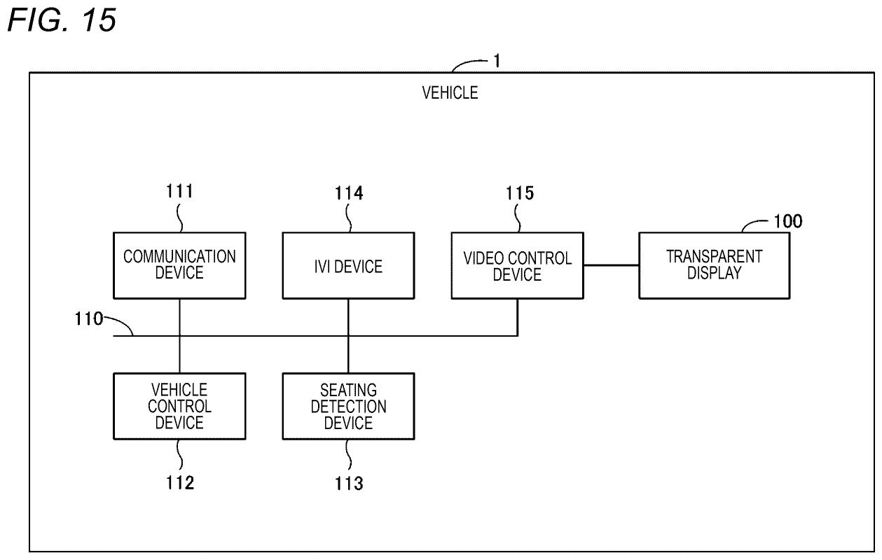

The vehicle 1 includes an operation unit 102 near the rear seat 22 inside the vehicle. The operation unit 102 may be a tablet terminal installed inside the vehicle. Alternatively, the operation unit 102 may connect a smartphone carried by the occupant to the vehicle 1 in a wired or wireless manner. Alternatively, the operation unit 102 may be a remote controller for operating an IVI device 114 (see FIG. 15).

The transparent display 100 provided between the rear seat 22 and the front seat 21 is touched by an occupant who is going to get on the rear seat 22 or an occupant who is going to get off the rear seat 22, and may be contaminated or damaged. Therefore, in the present embodiment, a technique for preventing an occupant who is going to get on the rear seat 22 or an occupant who is going to get off the rear seat 22 from touching the transparent display 100 provided between the rear seat 22 and the front seat 21 will be described. In the following description, an occupant who is going to get on the rear seat 22 or an occupant who is going to get off the rear seat 22 is referred to as a rear-seat occupant.

### <Configuration of Device>

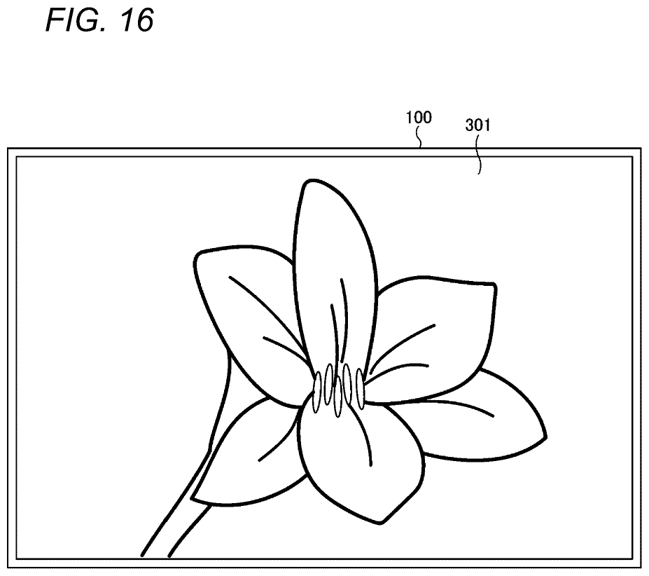

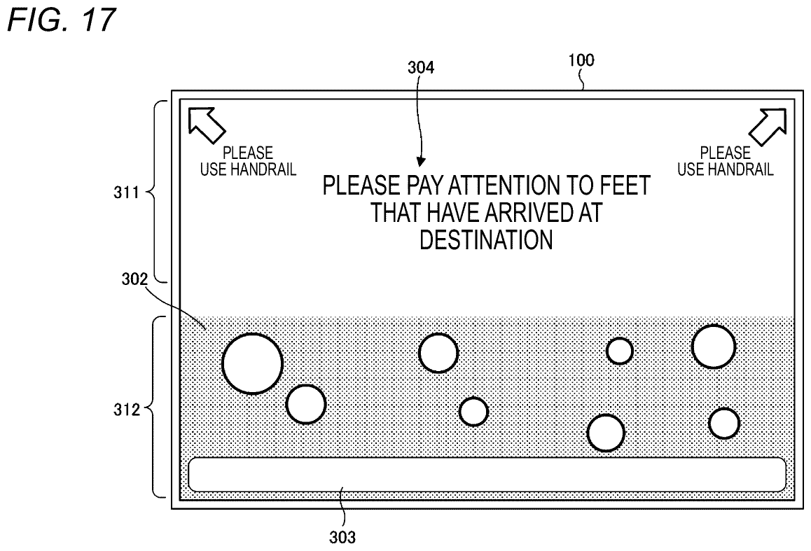

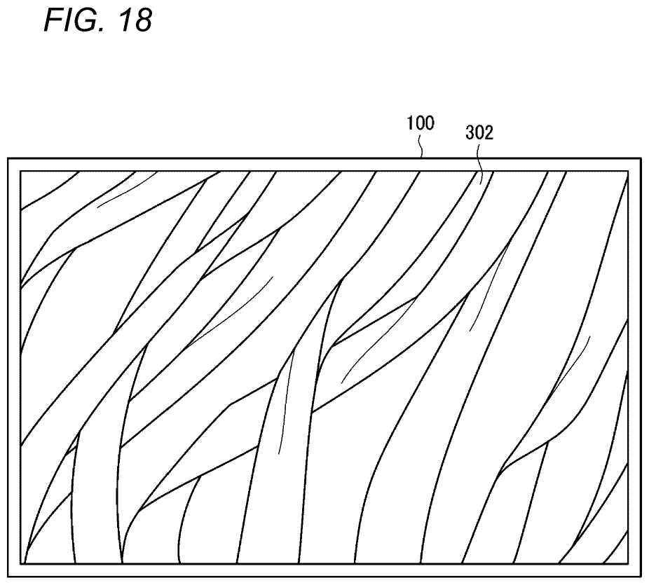

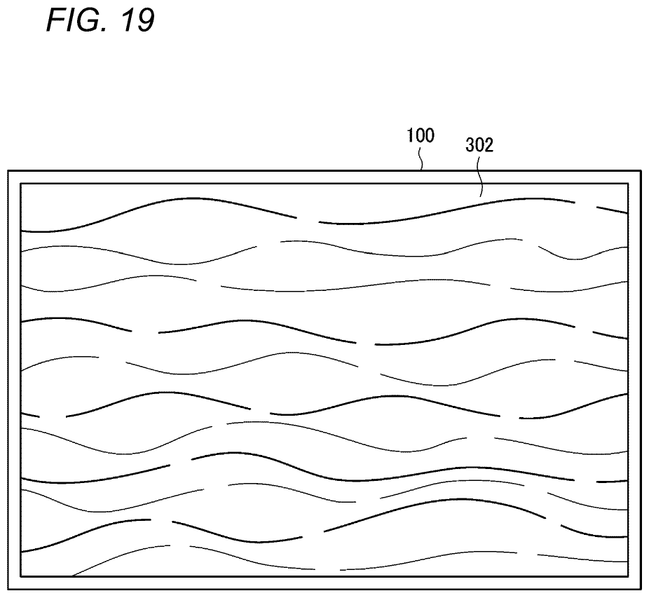

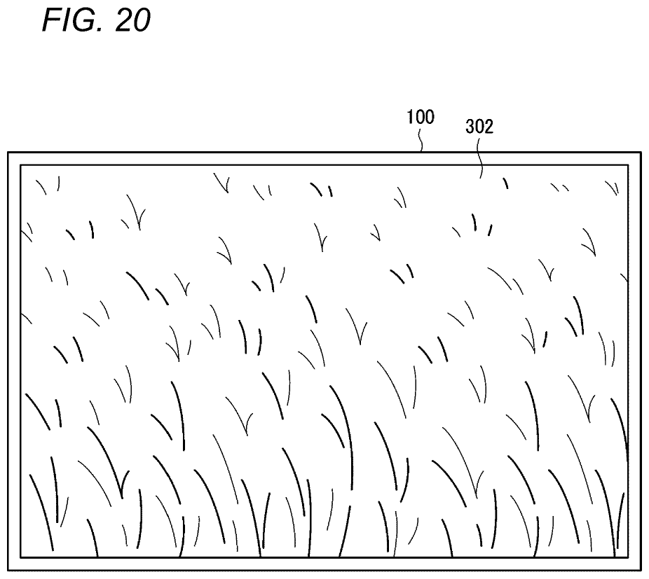

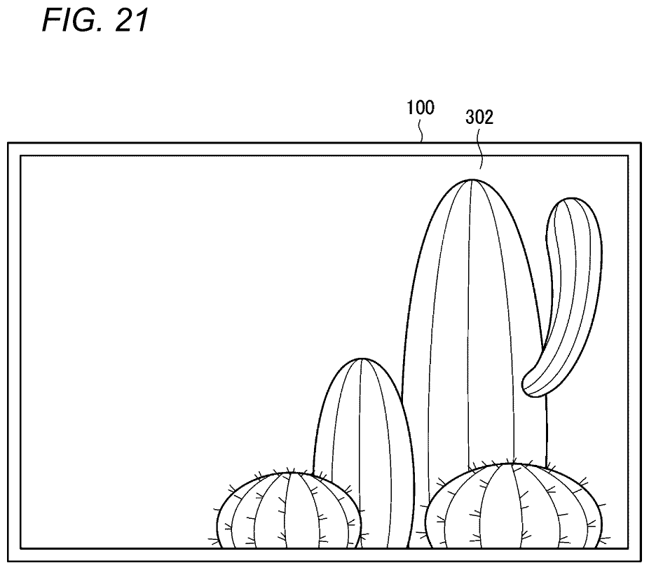

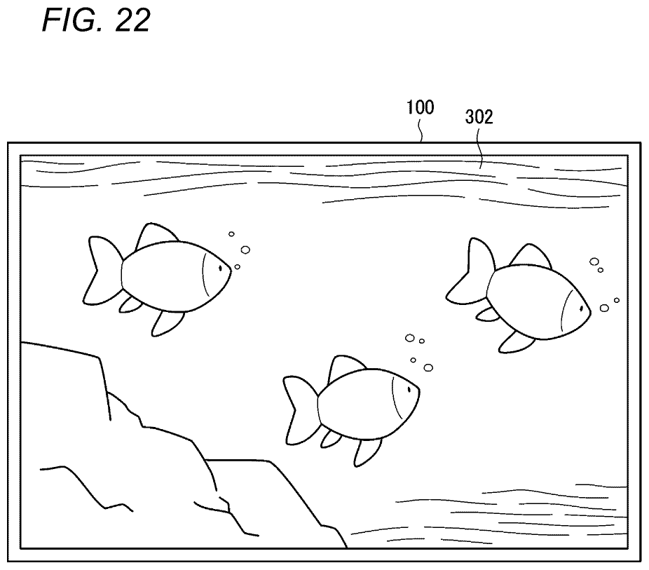

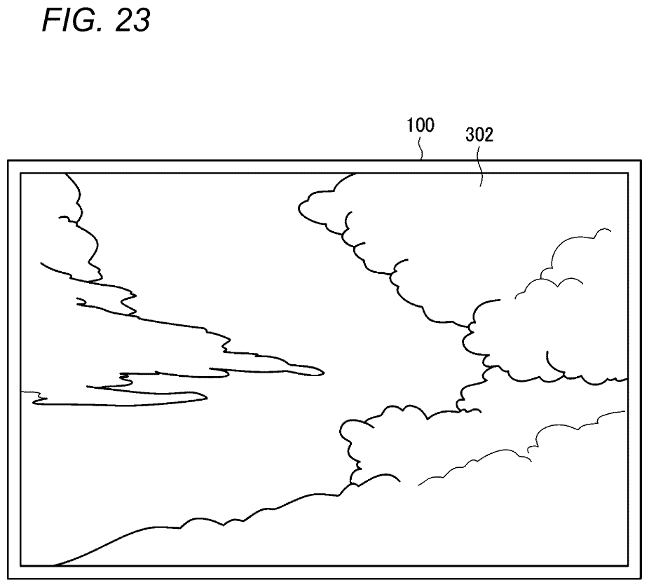

FIG. 15 is a block diagram illustrating an example of a device provided in the vehicle 1 according to Embodiment 2. FIG. 16 is a schematic diagram illustrating an example of first content 301 according to Embodiment 2. FIG. 17 is a schematic diagram illustrating a video of a predetermined pattern as an example of second content 302 according to Embodiment 2. FIG. 18 is a schematic diagram illustrating a video of a swinging curtain as an example of the second content 302 according to Embodiment 2. FIG. 19 is a schematic diagram illustrating a video of a water surface with waves as an example of the second content 302 according to Embodiment 2. FIG. 20 is a schematic diagram illustrating an example of a video of a grass swaying in wind as an example of the second content 302 according to Embodiment 2. FIG. 21 is a schematic diagram illustrating a video of a cactus as an example of the second content 302 according to Embodiment 2. FIG. 22 is a schematic diagram illustrating a video of fish swimming in water as an example of the second content 302 according to Embodiment 2. FIG. 23 is a schematic diagram illustrating an example of a video of clouds flowing as an example of the second content 302 according to Embodiment 2.

As illustrated in FIG. 15, the vehicle 1 includes the communication device 111, the vehicle control device 112, the seating detection device 113, the IVI device 114, the video control device 115, and the transparent display 100. The communication device 111, the vehicle control device 112, the seating detection device 113, the IVI device 114, and the video control device 115 can transmit and receive information to and from each other via the in-vehicle network 110. Examples of the in-vehicle network 110 include Controller Area Network (CAN), Local Interconnect Network (LIN), and FlexRay.

The communication device 111 is a device that performs wireless communication with another device (for example, a server or a smartphone) through a predetermined communication network. Examples of the communication network include a mobile communication network (for example, LTE, 4G, 5G, and 6G), Wi-Fi (registered trademark), and Bluetooth (registered trademark).

The vehicle control device 112 is a device that controls a behavior of the vehicle 1. For example, the vehicle control device 112 controls start and stop of the vehicle 1, opening and closing of a door, turning on and off of a headlight, and the like. The vehicle control device 112 provides information indicating states such as start and stop of the vehicle 1, opening and closing of a door, turning on and off of a headlight. The vehicle control device 112 provides an illuminance value measured by an illuminance sensor (not illustrated) for measuring illuminance outside or inside the vehicle.

The seating detection device 113 is a device for detecting whether an occupant is seated in each seat. For example, the seating detection device 113 may detect whether an occupant is seated in a seat by a weight sensor provided in the seat. Alternatively, the seating detection device 113 may detect whether an occupant is seated in a seat based on whether a seat belt of the seat is fastened. Alternatively, the seating detection device 113 may detect whether an occupant is seated in a seat by performing a person detection process at a position of the seat from an image captured by a camera (not illustrated) installed inside the vehicle.

The IVI device 114 is a device that provides information related to the vehicle 1 and provides entertainment. IVI is an abbreviation for “in-vehicle infotainment”. For example, the IVI device 114 outputs a music and a video, such as car audio, in-vehicle DVD, TV tuner, radio, and VOD. The IVI device 114 may be read as a control unit or an electronic control unit (ECU). The IVI device 114 may include a processor, a memory, and the like.

The IVI device 114 searches for and outputs a route to a destination. The IVI device 114 may search for a route to a destination using built-in map data, or may cause an external device to search for a route to a destination via the communication device 111 and acquire and output the search result. The route to the destination may be displayed as a navigation for a driver or may be used as an autonomous driving plan of the vehicle 1.

The IVI device 114 controls display of content on the transparent display 100 in cooperation with the video control device 115. Display of content according to the present embodiment will be described later.

The video control device 115 controls display of content on the transparent display 100. The content may be either a still image or a moving image. In addition, the video control device 115 can control the light transmittance in any region of the transparent display 100. The video control device 115 may control the display of the content on the transparent display 100 and the transmittance in any region under the control of the IVI device 114. The video control device 115 and the transparent display 100 may be included in a display device. Alternatively, the IVI device 114, the video control device 115, and the transparent display 100 may be included in the display device.

While the occupant in the rear seat 22 is on board, the transparent display 100 displays (reproduces) the first content 301 as illustrated in FIG. 16. The first content 301 is, for example, entertainment content for enjoying the occupant in the rear seat 22 or relaxation content for relaxing the occupant in the rear seat 22.

When the occupant in the rear seat 22 gets on or off, the transparent display 100 displays the second content 302 different from the first content 301, and sets a first light transmittance of the first display region 311 to be larger than a second light transmittance of the second display region 312 (see FIG. 17) below the first display region 311 (see FIG. 17). The second content 302 may be displayed in the second display region 312. However, the second content 302 may be displayed across the first display region 311 and the second display region 312. The first content 301 may be displayed larger than the second content 302. However, the first content 301 may be displayed smaller than the second content 302. The second content 302 is content that, when displayed on the transparent display 100, reduces the possibility that the rear-seat occupant touches the transparent display 100.

For example, the transparent display 100 displays a video for displaying a predetermined pattern as illustrated in FIG. 17, as the second content 302. For example, the transparent display 100 displays, as the second content 302, at least one of a video of a swinging curtain as illustrated in FIG. 18, a video of a water surface with waves as illustrated in FIG. 19, or a video of a grass swaying in wind as illustrated in FIG. 20. For example, the transparent display 100 may display, as the second content 302, at least one of a video of a cactus as illustrated in FIG. 21, a video of fish swimming in water as illustrated in FIG. 22, and a video of clouds flowing as illustrated in FIG. 23.

Such videos as illustrated in FIGS. 17 to 23 give the rear-seat occupant an impression that the weight is hard to be applied to (difficult to lean on) the transparent display by touching the transparent display. Therefore, by displaying such a video as the second content 302 on the transparent display 100, it is possible to prevent the rear-seat occupant from touching the transparent display 100 to maintain the posture balance. Therefore, it is possible to reduce contamination or breakage of the transparent display 100.

As illustrated in FIG. 17, the first display region 311 may be, for example, at least ¼ regions from the top to the bottom of the transparent display 100. The first light transmittance may be a transmittance (for example, transparent) at which the occupant views the scenery outside the vehicle through the transparent display 100 and the front window 4. Accordingly, since the rear-seat occupant can see the scenery inside and outside the vehicle at a height of a line of sight, it is easy to keep the posture balance, and it is possible to prevent the rear-seat occupant from losing the posture balance and touching the transparent display 100.

As illustrated in FIG. 17, the second display region 312 may be, for example, at least ¼ regions from the bottom to the top of the transparent display 100. The second light transmittance may be a transmittance (for example, non-transparency or light shielding) at which the second content 302 can be visually recognized well. Accordingly, there is a high possibility that the rear-seat occupant may view the video of the second content 302 displayed in the second display region 312 and touch the transparent display 100, and thus the rear-seat occupant can be prevented from consciously or unconsciously touching the transparent display 100.

As illustrated in FIGS. 14 and 17, when the occupant in the rear seat gets on or off, the transparent display 100 may display information indicating a position of the handrail 31 in the second content 302. This increases the possibility that the rear-seat occupant recognizes the position of the handrail 31 and holds the handrail 31, thereby reducing the possibility that the rear-seat occupant holds the transparent display 100.

As illustrated in FIGS. 14 and 17, at least a part of the second content 302 may provide a function of the illumination 303. The function of the illumination 303 may be provided when the illuminance outside the vehicle and/or inside the vehicle is equal to or less than a predetermined threshold. For example, the transparent display 100 provides a function of the illumination 303 by displaying white or a color having high brightness and saturation on at least a part of the second content 302. As a result, since the vicinity of the feet becomes bright by the function of the illumination 303, the rear-seat occupant can easily keep posture balance, and the rear-seat occupant can be prevented from losing the posture balance and touching the transparent display 100.

When the occupant in the rear seat 22 gets on or off, the transparent display 100 may display a message 304 for the occupant in the rear seat 22 in the second content 302. The message 304 for getting-on and the message 304 for getting-off may be different.

Examples of the message 304 for getting-on include the following. One message 304 for getting-on may be displayed, or a plurality of messages 304 for getting-on may be displayed.

A message of greeting according to the current time, such as “Good morning” or “Hello”.

A message including the name of the occupant, such as “Hello, Mr./Ms. XX”.

A message for calling attention, such as “Please pay attention to the foot”.

A message of appreciation, such as “Thank you for your boarding”.

A message indicating the future schedule and traffic information of the occupant, such as “There is no traffic and it is scheduled to reach the destination for 30 minutes”.

A message prompting relaxation such as “Please take it easy”.

A message indicating a destination of a vehicle, such as “This is a vehicle heading for XX”.

Examples of the message 304 for getting-off include the following. One message 304 for getting-off may be displayed, or a plurality of messages 304 for getting-off may be displayed.

A message for notifying an occupant of the arrival, such as “arrived at the destination”.

A message including the name of an occupant, such as “arrived at your home, Mr./Ms. XX”.

A message indicating a future schedule of an occupant, such as “The schedule at this destination is a meal with Mr./Ms. XX”.

A message for calling attention, such as “Please pay attention to the foot”.

A message indicating weather, such as “It rains outside”.

A message of appreciation, such as “Please use it”.

### <Process Flow>

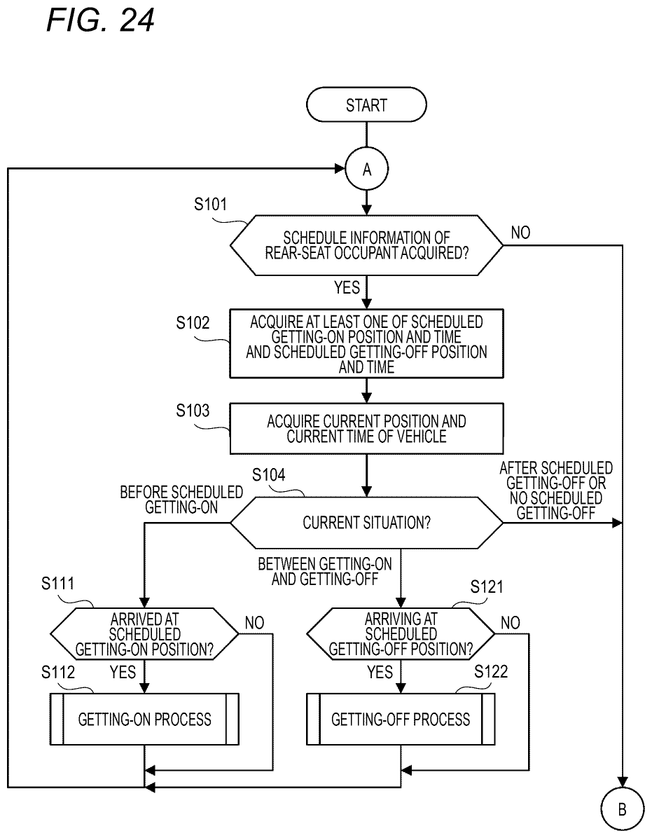

FIG. 24 is a flowchart illustrating an example of a situation determination process according to Embodiment 2.

The IVI device 114 determines whether schedule information of the rear-seat occupant is acquired (S101). For example, when the rear-seat occupant permits, the IVI device 114 acquires, via the communication device 111, the schedule information of the rear-seat occupant from a predetermined server or cloud service in which the schedule information of the rear-seat occupant is managed.

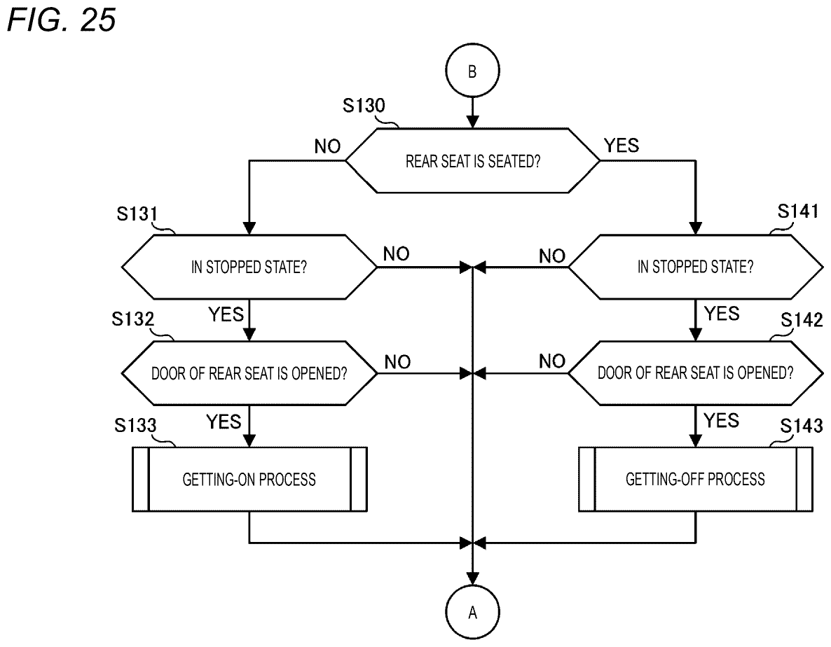

When the schedule information of the rear-seat occupant cannot be acquired (S101: NO), the process proceeds to a process B illustrated in FIG. 25. When the schedule information of the rear-seat occupant can be acquired (S101: YES), the following process is performed.

The IVI device 114 acquires at least one of a scheduled getting-on position and a scheduled getting-on time and a scheduled getting-off position and a scheduled getting-off time of the rear-seat occupant from the acquired schedule information (S102). For example, when a departure point and a destination are registered in the schedule information, the IVI device 114 sets the departure point as the scheduled getting-on position and the destination as the scheduled getting-off position. For example, when a departure time and an arrival time are registered in the schedule information, the IVI device 114 sets the departure time as a scheduled getting-on time and the arrival time as the scheduled getting-off time.

The IVI device 114 acquires a current position and a current time of the vehicle 1 (S103). For example, the IVI device 114 specifies the current position and the current time of the vehicle 1 from a car navigation system.

The IVI device 114 collates at least one of the scheduled getting-on position and the scheduled getting-on time and the scheduled getting-off position and the scheduled getting-off time acquired in step S101 with the current position and current time of the vehicle 1 acquired in step S103, and specifies a current situation of the vehicle 1 (S104). For example, (a) when the current position of the vehicle 1 is before the scheduled getting-on position or when the current time is before the scheduled getting-on time, the IVI device 114 specifies the current situation of the vehicle 1 as “before scheduled getting-on”. For example, (b) when the current position of the vehicle 1 is between the scheduled getting-on position and the scheduled getting-off position, or when the current time is between the scheduled getting-on time and the scheduled getting-off time, the IVI device 114 specifies the current situation of the vehicle 1 as “between getting-on and getting-off”. For example, when neither (a) nor (b) is satisfied, the IVI device 114 specifies the current situation of the vehicle 1 as “after scheduled getting-off or without scheduled getting-off”.

When the current situation of the vehicle 1 is specified as “after scheduled getting-off or without scheduled getting-off” in step S104, the process proceeds to the process B illustrated in FIG. 25.

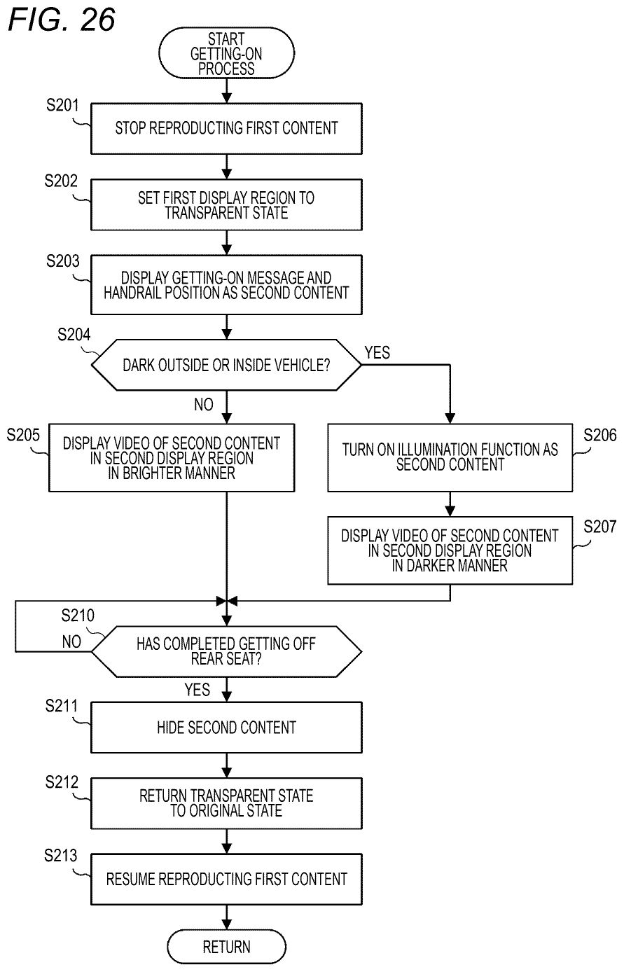

When the current situation of the vehicle 1 is specified as “before scheduled getting-on” in step S104, the following process is performed. That is, the IVI device 114 determines whether the vehicle 1 has arrived at the scheduled getting-on position (S111). In response to determining that the vehicle 1 has arrived at the scheduled getting-on position (S111: YES), the IVI device 114 performs a getting-on process (S112) and returns the process to step S101. Details of the getting-on process will be described later (see FIG. 26). When the IVI device 114 determines that the vehicle 1 has not arrived at the scheduled getting-on position (S111: NO), the process returns to step S101.

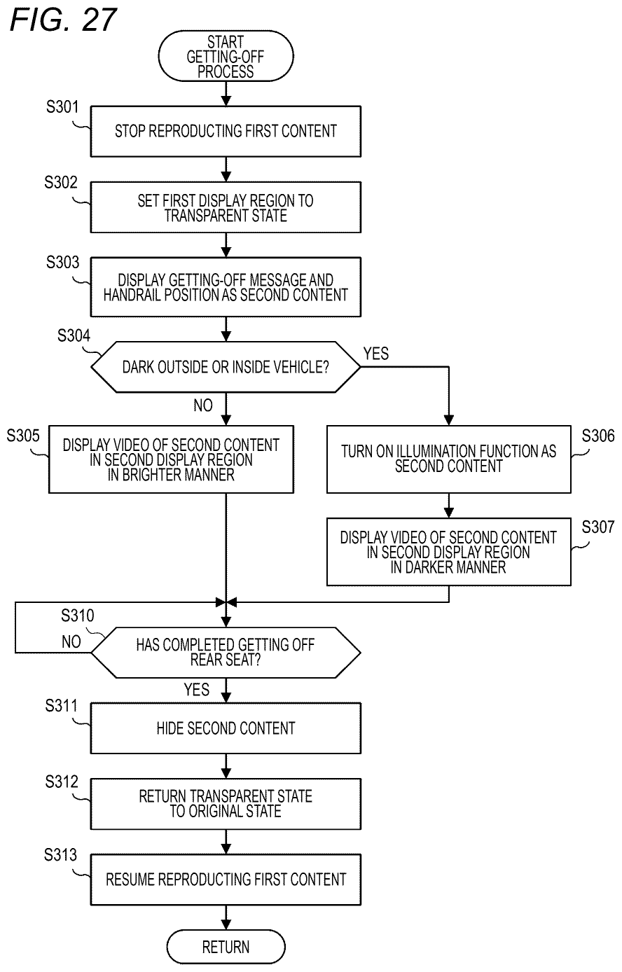

When the current situation of the vehicle 1 is specified as “between getting-on and getting-off” in step S104, the following process is performed. That is, the IVI device 114 determines whether the vehicle 1 has arrived at the scheduled getting-off position (S121). In response to determining that the vehicle 1 has arrived at the scheduled getting-off position (S121: YES), the IVI device 114 performs a getting-off process (S112) and returns the process to step S101. Details of the getting-off process will be described later (see FIG. 27). When the IVI device 114 determines that the vehicle 1 has not arrived at the scheduled getting-off position (S121: NO), the process returns to step S101.

FIG. 25 is a flowchart illustrating an example of the process B following the process illustrated in FIG. 24.

The IVI device 114 determines whether an occupant is seated on the rear seat 22 based on the detection result by the seating detection device 113 (S130).

In response to determining in step S130 that no occupant is seated in the rear seat 22 (S130: NO), the following process is performed.

The IVI device 114 determines whether the vehicle 1 is in a stopped state based on the information obtained from the vehicle control device 112 (S131). The IVI device 114 determines that the vehicle 1 is in a stopped state, for example, when the speed of the vehicle 1 is 0, when a shift lever is in a parking position, and/or when a parking brake is on.

In response to determining that the vehicle 1 is not in a stopped state (S131: NO), the IVI device 114 returns the process to a process A (that is, step S101) illustrated in FIG. 24.

In response to determining that the vehicle 1 is in a stopped state (S131: YES), the IVI device 114 determines whether the door 23 (see FIG. 14) of the rear seat is opened based on the information obtained from the vehicle control device (S132).

In response to determining that the door 23 of the rear seat is not opened (S132: NO), the IVI device 114 returns the process to a process A (that is, step S101) illustrated in FIG. 24.

In response to determining that the door 23 of the rear seat is opened (S132: YES), the IVI device 114 performs the getting-on process (S133) and returns the process to the process A (that is, step S101) illustrated in FIG. 24. Details of the getting-on process will be described later (see FIG. 26).

That is, when the vehicle 1 stops and the door 23 of the rear seat is opened in a state where no occupant is seated in the rear seat 22, the IVI device 114 determines that an occupant gets on the rear seat 22 and performs the getting-on process.

In response to determining in step S130 that an occupant is seated in the rear seat 22 (S130: YES), the following process is performed.

The IVI device 114 determines whether the vehicle 1 is in a stopped state based on the information obtained from the vehicle control device 112 (S141).

In response to determining that the vehicle 1 is not in a stopped state (S141: NO), the IVI device 114 returns the process to the process A (that is, step S101) illustrated in FIG. 24.

In response to determining that the vehicle 1 is in a stopped state (S141: YES), the IVI device 114 determines whether the door 23 of the rear seat is opened based on the information obtained from the vehicle control device (S132).

In response to determining that the door 23 of the rear seat is not opened (S142: NO), the IVI device 114 returns the process to the process A (that is, step S101) illustrated in FIG. 24.

In response to determining that the door 23 of the rear seat is opened (S142: YES), the IVI device 114 performs the getting-off process (S143) and returns the process to the process A (that is, step S101) illustrated in FIG. 24. Details of the getting-off process will be described later (see FIG. 27).

That is, when the vehicle 1 stops and the door 23 of the rear seat is opened in a state where an occupant is seated on the rear seat 22, the IVI device 114 determines that the occupant of the rear seat 22 gets off and performs the getting-off process.

### <Getting-On Process Flow>

FIG. 26 is a flowchart illustrating an example of a getting-on process according to Embodiment 2. The getting-on process is called in step S112 illustrated in FIG. 24 or step S133 illustrated in FIG. 25.

The IVI device 114 stops reproducing the first content 301 on the transparent display 100 (S201).

The IVI device 114 sets the first light transmittance of the first display region 311 in the transparent display 100 to be larger than the second light transmittance of the second display region 312. For example, the IVI device 114 sets the first display region 311 in the transparent display 100 to a transparent state (S202).

The IVI device 114 displays the message 304 for getting-on and the position of the handrail 31 on the transparent display 100 as the second content (S203).

The IVI device 114 determines whether the outside or the inside of the vehicle is dark (S204). For example, the IVI device 114 determines that the outside or the inside of the vehicle is dark when an illuminance value measured by an illuminance sensor installed outside or inside the vehicle is less than a predetermined threshold, and determines that the outside or the inside of the vehicle is bright when the illuminance value is equal to or larger than the threshold. Alternatively, the IVI device 114 determines that the outside or the inside of the vehicle is dark when the headlight of the vehicle 1 is turned on, and determines that the outside or the inside of the vehicle is bright when the headlight is turned off. The turning on/off of the headlight may be manually switched by a driver, or may be automatically switched according to the illuminance value by the illuminance sensor. Alternatively, the IVI device 114 may determine that the outside or the inside of the vehicle is dark (that is, determine to be night) when the current time is within a preset nighttime time, and may determine that the outside or the inside of the vehicle is bright (that is, determine not to be night) when the current time is not within the nighttime time.

In response to determining that the outside or the inside of the vehicle is bright (S204: NO), the IVI device 114 displays a video of the second content 302 in the second display region 312 (for example, a light-shielding region) of the transparent display 100 in a brighter manner (S205). Then, the process proceeds to step S210.

In response to determining that the outside or the inside of the vehicle is dark (S204: YES), the IVI device 114 turns on the function of the illumination 303 as second content 302 (S206). The IVI device 114 displays the video of the second content 302 in the second display region 312 (for example, a light-shielding region) of the transparent display 100 in a darker manner (S207). Then, the process proceeds to step S210.

In step S210, the IVI device 114 determines whether the occupant has completed getting off the rear seat 22 (S210). For example, when the IVI device 114 detects that the opened door 23 of the rear seat is closed from the information obtained from the vehicle control device 112, the IVI device 114 determines that the occupant has completed getting on the rear seat 22. For example, when the seating detection device 113 detects the seating of the rear seat 22, the IVI device 114 determines that the occupant has completed getting-on the rear seat 22. For example, when the seating detection device 113 detects that the seat belt of the rear seat 22 is worn, the IVI device 114 determines that the occupant has completed getting-on the rear seat.

In response to determining that the occupant has not completed getting on the rear seat 22 (S210: NO), the IVI device 114 repeats the process of step S210. In response to determining that the occupant has completed getting off the rear seat 22 (S210: YES), the following process is performed.

The IVI device 114 hides the second content 302 being displayed on the transparent display 100 (S211).

The IVI device 114 returns the transparent state of the transparent display 100 to an original state when the first content 301 is reproduced (S212).

The IVI device 114 resumes reproduction of the first content 301 on the transparent display 100 (S213).

The present getting-on process is completed, and the process returns to a calling process (a process after step S112 in FIG. 24 or step S133 in FIG. 25).

### <Getting-Off Process Flow>

FIG. 27 is a flowchart illustrating an example of a getting-off process according to Embodiment 2. The getting-off process is called in step S122 illustrated in FIG. 24 or step S143 illustrated in FIG. 25.

The IVI device 114 stops reproducing the first content 301 on the transparent display 100 (S301).

The IVI device 114 sets the first light transmittance of the first display region 311 in the transparent display 100 to be larger than the second light transmittance of the second display region 312. For example, the IVI device 114 sets the first display region in the transparent display 100 to a transparent state (S302).

The IVI device 114 displays the message 304 for getting-off and the position of the handrail 31 on the transparent display as the second content 302 (S303).

The IVI device 114 determines whether the outside or the inside of the vehicle is dark (S304).

In response to determining that the outside or the inside of the vehicle is bright (S304: NO), the IVI device 114 displays a video of the second content 302 in the second display region 312 (for example, a light-shielding region) of the transparent display 100 in a brighter manner (S305). The video of the second content 302 at the time of getting off may be the same as or different from the video of the second content 302 at the time of getting on. Then, the process proceeds to step S310.

In response to determining that the outside or the inside of the vehicle is dark (S304:
YES), the IVI device 114 turns on the function of the illumination 303 as the second content 302 (S206). The IVI device 114 displays the video of the second content 302 in the second display region 312 (for example, a light-shielding region) of the transparent display 100 in a darker manner (S207). Then, the process proceeds to step S310.

In step S310, the IVI device 114 determines whether the occupant has completed getting off the rear seat 22 (S210). For example, when the IVI device 114 detects that the opened door 23 of the rear seat is closed from the information obtained from the vehicle control device 112, the IVI device 114 determines that the occupant has completed getting off the rear seat 22. For example, when the seating of the rear seat 22 is changed from a detection state to a non-detection state in the seating detection device 113, the IVI device 114 determines that the occupant has completed getting off the rear seat 22. For example, when the seating detection device 113 detects that the seat belt of the rear seat 22 is changed from being worn to being unworn, the IVI device 114 determines that the occupant has completed getting off the rear seat 22.

In response to determining that the occupant has not completed getting off the rear seat 22 (S310: NO), the IVI device 114 repeats the process of step S310. In response to determining that the occupant has completed getting off the rear seat 22 (S310: YES), the following process is performed.

The IVI device 114 hides the second content 302 being displayed on the transparent display 100 (S311).

The IVI device 114 returns the transparent state of the transparent display 100 to an original state when the first content 301 is reproduced (S312).

The IVI device 114 resumes reproduction of the first content 301 on the transparent display 100 (S313).

The present getting-off process is completed, and the process returns to a calling process (a process after step S122 in FIG. 24 or step S143 in FIG. 25).

### Summary of Embodiment 2

The following techniques are disclosed from the above description of Embodiment 2.

### <Technique B1>

The vehicle 1 includes at least the first wheel 3A coupled to the vehicle body 2, the second wheel 3B coupled to the vehicle body 2, the third wheel 3C coupled to the vehicle body 2, and the fourth wheel 3D coupled to the vehicle body 2, and is capable of traveling in a predetermined direction using the first wheel 3A, the second wheel 3B, the third wheel 3C, and the fourth wheel 3D.

The vehicle body 2 includes: the floor surface portion 11 and the ceiling surface portion 12 disposed along the predetermined direction; the left side surface portion 13 connecting the floor surface portion 11 and the ceiling surface portion 12 and disposed on the left side surface along the predetermined direction; the right side surface portion 14 connecting the floor surface portion 11 and the ceiling surface portion 12 and disposed on the right side surface along the predetermined direction; the front surface portion 16 connecting the floor surface portion 11 and the ceiling surface portion 12 and disposed in the front portion 15 along the predetermined direction; the rear surface portion 18 connecting the floor surface portion 11 and the ceiling surface portion 12 and disposed in the rear portion 17 along the predetermined direction; at least one front seat 21 disposed closer to the front surface portion 16 side than the rear surface portion on the floor surface portion 11; at least one rear seat 22 disposed closer to the rear surface portion 18 side than the front surface portion 16 on the floor surface portion 11; and the transparent display 100 disposed between the rear seat 22 and the front seat 21 and having a variable light transmittance.

As the vehicle control method in the vehicle 1, the transparent display 100 displays the first content 301 while the occupant in the rear seat 22 is on board, and when the occupant in the rear seat 22 gets on or off the vehicle 1, the transparent display 100 displays the second content 302 different from the first content 301, and sets the first light transmittance of the first display region 311 to be larger than the second light transmittance of the second display region 312 below the first display region 311.

Accordingly, since the rear-seat occupant can visually recognize the outside or the inside of the vehicle through the first display region 311 having a relatively high light transmittance of the transparent display 100, it is easy to keep the posture balance, and it is possible to prevent the rear-seat occupant from losing the posture balance and touching the transparent display 100.

### <Technique B2>

In the vehicle control method according to technique B1, the second content 302 is displayed in the second display region 312.

Accordingly, since the second content 302 is displayed in the second display region 312 having a relatively low light transmittance, the rear-seat occupant can visually recognize the second content 302 well.

### <Technique B3>

In the vehicle control method according to technique B1 or B2, at least a part of the second content 302 provides a function of the illumination 303.

Accordingly, since the feet of the rear-seat occupant are illuminated by the function of the illumination 303 and become bright, the rear-seat occupant can easily maintain the posture balance, and the rear-seat occupant can be prevented from losing the posture balance and touching the transparent display 100.

<technique B4>

In the vehicle control method according to technique B3, the function of the illumination 303 is provided when illuminance outside the vehicle and/or inside the vehicle is equal to or smaller than a predetermined threshold.

Thus, when the outside of the vehicle and/or the inside of the vehicle is relatively dark, the feet of the rear-seat occupant are illuminated by the function of the illumination 303.

### <Technique B5>

In the vehicle control method according to any one of techniques B1 to B4, when an occupant in the rear seat 22 gets on or gets off, the transparent display 100 displays the message 304 for the occupant in the rear seat 22 in the second content 302.

Accordingly, the rear-seat occupant can visually recognize the message 304 displayed on the transparent display 100.

<technique B6>

In the vehicle control method according to any one of techniques B1 to B5, the transparent display 100 displays information indicating the position of the handrail 31 in the second content 302 when the occupant in the rear seat 22 gets on or gets off.

Accordingly, the possibility that the rear-seat occupant gets on the handrail 31 increases, and the rear-seat occupant can be prevented from consciously or unconsciously touching the transparent display 100.

### <Technique B7>

In the vehicle control method according to any one of techniques B1 to B6, the transparent display 100 displays a predetermined pattern in the second content 302 when an occupant in the rear seat 22 gets on or gets off.

Accordingly, the rear-seat occupant can visually recognize the transparent display 100 on which a predetermined pattern is displayed as the second content 302, and the rear-seat occupant can be prevented from consciously or unconsciously touching the transparent display 100.

<technique B8>

In the vehicle control method according to any one of techniques B1 to B6, when an occupant in the rear seat 22 gets on or off the vehicle, the transparent display 100 displays, in the second content 302, at least one of a swaying curtain, a waved water surface, and a grass swaying in wind.

Since such second content 302 gives an impression that it is difficult for the rear-seat occupant to lean against the transparent display 100, it is possible to prevent the rear-seat occupant from leaning against the transparent display 100 with a hand.

### <Technique B9>

In the vehicle control method according to any one of techniques B1 to B8, the vehicle 1 includes a control unit (for example, the IVI device 114), and the control unit determines whether an occupant in the rear seat 22 gets on or gets off based on schedule information of the occupant in the rear seat 22.

Accordingly, it is possible to distinguish between an occupant who is going to get on the vehicle and an occupant who gets off the vehicle.

### <Technique B10>

In the vehicle control method according to any one of the techniques B1 to B9, the transparent display 100 resumes the display of the first content 301 after the occupant in the rear seat 22 completes getting on or off.

Accordingly, the transparent display 100 can resume the display of the first content 301 after the display is switched from the first content 301 to the second content 302 and the occupant completes getting on or off.

<technique B11>

The vehicle 1 includes at least the first wheel 3A coupled to the vehicle body 2, the second wheel 3B coupled to the vehicle body 2, the third wheel 3C coupled to the vehicle body 2, and the fourth wheel 3D coupled to the vehicle body 2, and is capable of traveling in a predetermined direction using the first wheel 3A, the second wheel 3B, the third wheel 3C, and the fourth wheel 3D. The display device is set to be mounted on the vehicle 1.

The vehicle body 2 includes: the floor surface portion 11 and the ceiling surface portion 12 disposed along the predetermined direction; the left side surface portion 13 connecting the floor surface portion 11 and the ceiling surface portion 12 and disposed on the left side surface along the predetermined direction; the right side surface portion 14 connecting the floor surface portion 11 and the ceiling surface portion 12 and disposed on the right side surface along the predetermined direction; the front surface portion 16 connecting the floor surface portion 11 and the ceiling surface portion 12 and disposed in the front portion 15 along the predetermined direction; the rear surface portion 18 connecting the floor surface portion 11 and the ceiling surface portion 12 and disposed in the rear portion 17 along the predetermined direction; at least one front seat 21 disposed closer to the front surface portion 16 side than the rear surface portion 18 on the floor surface portion 11; at least one rear seat 22 disposed closer to the rear surface portion 18 side than the front surface portion 16 on the floor surface portion 11; and the transparent display 100 disposed between the rear seat 22 and the front seat 21 and having a variable light transmittance.

As a display device, the transparent display 100 displays the first content 301 while the occupant in the rear seat 22 is on board, and when the occupant in the rear seat 22 gets on or off the vehicle, the transparent display 100 displays the second content 302 different from the first content 301, and sets the first light transmittance of the first display region 311 to be larger than the second light transmittance of the second display region 312 below the first display region 311.

Accordingly, since the rear-seat occupant can visually recognize the outside or the inside of the vehicle through the first display region 311 having a relatively high light transmittance of the transparent display 100, it is easy to keep the posture balance, and it is possible to prevent the rear-seat occupant from losing the posture balance and touching the transparent display 100.

### <Technique B12>

In the display device according to technique B11, the second content 302 is displayed in the second display region 312.

Accordingly, since the second content 302 is displayed in the second display region 312 having a relatively low light transmittance, the rear-seat occupant can visually recognize the second content 302 well.

### <Technique B13>

In the display device according to technique B11 or B12, at least a part of the second content 302 provides a function of the illumination 303.

Accordingly, since the feet of the rear-seat occupant are illuminated by the function of the illumination 303 and become bright, the rear-seat occupant can easily maintain the posture balance, and the rear-seat occupant can be prevented from losing the posture balance and touching the transparent display 100.

<technique B14>

In the display device according to technique B13, the function of the illumination 303 is provided when illuminance outside the vehicle and/or inside the vehicle is equal to or smaller than a predetermined threshold.

Accordingly, when the outside of the vehicle and/or the inside of the vehicle is relatively dark, the feet of the rear-seat occupant are illuminated by the function of the illumination 303.

<technique B15>

In the display device according to any one of techniques B11 to B14, when an occupant in the rear seat 22 gets on or gets off, the transparent display 100 displays the message 304 for the occupant in the rear seat 22 in the second content 302.

Accordingly, the rear-seat occupant can visually recognize the message 304 displayed on the transparent display 100.

### <Technique B16>

In the display device according to any one of techniques B11 to B15, the transparent display 100 displays information indicating the position of the handrail 31 in the second content 302 when the occupant in the rear seat 22 gets on or gets off.

Accordingly, the possibility that the rear-seat occupant gets on the handrail 31 increases, and the rear-seat occupant can be prevented from consciously or unconsciously touching the transparent display 100.

### <Technique B17>

In the display device according to any one of techniques B11 to B16, the transparent display 100 displays a predetermined pattern in the second content 302 when an occupant in the rear seat 22 gets on or gets off.

Accordingly, the rear-seat occupant can visually recognize the transparent display 100 on which a predetermined pattern is displayed as the second content 302, and the rear-seat occupant can be prevented from consciously or unconsciously touching the transparent display 100.

<technique B18>

In the display device according to any one of techniques B11 to B16, when an occupant in the rear seat 22 gets on or off the vehicle, the transparent display 100 displays, in the second content, at least one of a swaying curtain, a waved water surface, and a grass swaying in wind.

Since such second content 302 gives an impression that it is difficult for the rear-seat occupant to lean against the transparent display 100, it is possible to prevent the rear-seat occupant from leaning against the transparent display 100 with a hand.

### <Technique B19>

In the display device according to any one of techniques B11 to B18, the vehicle 1 includes a control unit (for example, the IVI device 114), and the control unit determines whether an occupant in the rear seat 22 gets on or gets off based on schedule information of the occupant in the rear seat.

Accordingly, it is possible to distinguish between an occupant who is going to get on the vehicle and an occupant who gets off the vehicle.

### <Technique B20>

In the display device according to any one of the techniques B11 to B19, the transparent display 100 resumes the display of the first content 301 after the occupant in the rear seat 22 completes getting on or off.

Accordingly, the transparent display 100 can resume the display of the first content 301 after the display is switched from the first content 301 to the second content 302 and the occupant completes getting on or off.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. Components in the embodiment described above may be combined freely within a range without departing from the gist of the invention.

The present application is based on a Japanese patent application filed on Aug. 9, 2023 (Japanese Patent Application No. 2023-130287, Japanese Patent Application No. 2023-130288), and the contents thereof are incorporated herein by reference.

### Industrial Applicability

The technique of the present disclosure is useful for a vehicle including a display inside the vehicle.

### Cross-Reference to Related Applications

This is a continuation of International Application No. PCT/JP2024/018530 filed on May 20, 2024, and claims priority from Japanese Patent Application No. 2023-130287 filed on Aug. 9, 2023 and Japanese Patent Application No. 2023-130288 filed on Aug. 9, 2023, the entire contents of which are incorporated herein by reference.

What is claimed is:

1. A vehicle control method for a vehicle, the vehicle including at least
a first wheel coupled to a vehicle body,
a second wheel coupled to the vehicle body,
a third wheel coupled to the vehicle body, and
a fourth wheel coupled to the vehicle body,
the vehicle being capable of traveling in a predetermined direction using the first wheel, the second wheel, the third wheel, and the fourth wheel, and
the vehicle body including
a floor surface portion and a ceiling surface portion disposed along the predetermined direction,
a left side surface portion connecting the floor surface portion and the ceiling surface portion and disposed on a left side surface along the predetermined direction,
a right side surface portion connecting the floor surface portion and the ceiling surface portion and disposed on a right side surface along the predetermined direction,
a front surface portion connecting the floor surface portion and the ceiling surface portion and disposed in a front portion along the predetermined direction,
a rear surface portion connecting the floor surface portion and the ceiling surface portion and disposed in a rear portion along the predetermined direction,
at least one front seat disposed closer to a front surface portion side than the rear surface portion on the floor surface portion,
at least one rear seat disposed closer to a rear surface portion side than the front surface portion on the floor surface portion, and
a display disposed between the rear seat and the front seat, wherein
in a case that a first condition is satisfied, the display displays a video in a first size with a video center at a first position, and
in a case that a second condition different from the first condition is satisfied, the display displays the video in a second size smaller than the first size with the video center at a second position.

2. The vehicle control method according to claim 1, wherein
the second position is on a left side of the first position, or
the second position is on a right side of the first position.

3. The vehicle control method according to claim 1, wherein
the first condition is that acceleration of the vehicle in a predetermined direction is a first magnitude, and
the second condition is that acceleration of the vehicle in the predetermined direction is a second magnitude greater than the first magnitude.

4. The vehicle control method according to claim 3, wherein
the first magnitude of the acceleration in the predetermined direction is a magnitude of a time average over a predetermined time, and
the second magnitude of the acceleration in the predetermined direction is a magnitude of a time average of the predetermined time.

5. The vehicle control method according to claim 3, wherein
the predetermined direction is at least one of a left-right direction of the vehicle, an up-down direction of the vehicle, and a front-rear direction of the vehicle.

6. The vehicle control method according to claim 1, wherein
in a case that the first condition is satisfied, the display displays the video in the first size with the video center at the first position, then
in a case that the second condition is satisfied, the display displays the video in the second size with the video center at the second position, and then
in a case that the first condition is satisfied, the display displays the video in the first size with the video center at the first position.

7. The vehicle control method according to claim 1, wherein
in case that the second condition is satisfied, the display displays the video in the second size smaller than the first size with the video center at the second position, and displays the video in a third size smaller than the first size with the video center at a third position, and
the second position is on a left side of the first position and the third position is on a right side of the first position.

8. The vehicle control method according to claim 1, wherein
the vehicle includes a seating position detection circuit configured to detect a seating position of an occupant in the rear seat, and
the second position corresponds to the seating position of the occupant.

9. The vehicle control method according to claim 1, wherein
the second position is lower than the first position.

10. The vehicle control method according to claim 1, wherein
in a case that the second condition is satisfied, the display displays the video in the second size with the video center at the second position, and displays information indicating that the video is intentionally reduced.

11. A display device mounted on a vehicle, the vehicle including at least
a first wheel coupled to a vehicle body,
a second wheel coupled to the vehicle body,
a third wheel coupled to the vehicle body, and
a fourth wheel coupled to the vehicle body,
the vehicle being capable of traveling in a predetermined direction using the first wheel, the second wheel, the third wheel, and the fourth wheel,
the vehicle body including
a floor surface portion and a ceiling surface portion disposed along the predetermined direction,
a left side surface portion connecting the floor surface portion and the ceiling surface portion and disposed on a left side surface along the predetermined direction,
a right side surface portion connecting the floor surface portion and the ceiling surface portion and disposed on a right side surface along the predetermined direction,
a front surface portion connecting the floor surface portion and the ceiling surface portion and disposed in a front portion along the predetermined direction,
a rear surface portion connecting the floor surface portion and the ceiling surface portion and disposed in a rear portion along the predetermined direction,
at least one front seat disposed closer to a front surface portion side than the rear surface portion on the floor surface portion,
at least one rear seat disposed closer to a rear surface portion side than the front surface portion on the floor surface portion, and
a display disposed between the rear seat and the front seat, wherein
in a case that a first condition is satisfied, the display displays a video in a first size with a video center at a first position, and
in a case that a second condition different from the first condition is satisfied, the display displays the video in a second size smaller than the first size with the video center at a second position.

12. The display device according to claim 11, wherein
the second position is on a left side of the first position, or
the second position is on a right side of the first position.

13. The display device according to claim 11, wherein
the first condition is that acceleration of the vehicle in a predetermined direction is a first magnitude, and
the second condition is that acceleration of the vehicle in the predetermined direction is a second magnitude greater than the first magnitude.

14. The display device according to claim 13, wherein
the first magnitude of the acceleration in the predetermined direction is a magnitude of a time average over a predetermined time, and
the second magnitude of the acceleration in the predetermined direction is a magnitude of a time average of the predetermined time.

15. The display device according to claim 13, wherein
the predetermined direction is at least one of a left-right direction of the vehicle, an up-down direction of the vehicle, and a front-rear direction of the vehicle.

16. The display device according to claim 11, wherein
in a case that the first condition is satisfied, the display displays the video in the first size with the video center at the first position, then
in a case that the second condition is satisfied, the display displays the video in the second size with the video center at the second position, and then
in a case that the first condition is satisfied, the display displays the video in the first size with the video center at the first position.

17. The display device according to claim 11, wherein
in a case that the second condition is satisfied, the display displays the video in the second size smaller than the first size with the video center at the second position, and displays the video in a third size smaller than the first size with the video center at a third position, and
the second position is on a left side of the first position and the third position is on a right side of the first position.

18. The display device according to claim 11, wherein
the vehicle includes a seating position detection circuit configured to detect a seating position of an occupant in the rear seat, and
the second position corresponds to the seating position of the occupant.

19. The display device according to claim 11, wherein
the second position is below the first position.

20. The display device according to claim 11, wherein
in a case that the second condition is satisfied, the display displays the video in the second size with the video center at the second position, and displays information indicating that the video is intentionally reduced.
